(19) United States
(12) Patent Application Publication
(10) Pub. No.: US 2026/0169693 A1
(43) Pub. Date: Jun. 18, 2026

(54) EFFICIENT BITS SELECTION FOR ARBITRARY ACCUMULATION LOOPS WITH MINIMAL PRECISION

(71) Applicant: International Business Machines Corporation, Armonk, NY (US)

(72) Inventors: Elena Ferro, Adliswil (CH); Irem Sanli, Adliswil (CH); Athanasios Vasilopoulos, Zurich (CH); Irem Boybat Kara, Adliswil (CH)

(21) Appl. No.: 18/981,413

(22) Filed: Dec. 13, 2024

(51) Int. Cl. G06F 7/50

(52) U.S. Cl. CPC G06F 7/50

(57) ABSTRACT

A count of bits of a design of an accumulation register that ensures that a final accumulated value conforms to a specified precision is computed and a sign extension parameter that defines a count of extension bits of the accumulation register is determined. A count of most significant bits and a count of least significant bits to cut are computed for each of a set of candidate steps of an accumulation loop. An accumulation of a given count of numbers for the accumulation register design is performed. A set of bits of the accumulation register design to output after completion of the performance of the accumulation operation is selected based on the count of most significant bits and the count of least significant bits. An electronic circuit comprising a physical accumulation register that is configured to output the selected set of bits of the accumulation register design is instantiated.

### BACKGROUND

The present invention relates generally to the electrical, electronic and computer arts and, more particularly, to computer-aided hardware design and machine learning, and the conjunction of computer-aided hardware design and machine learning for hardware accelerator design devised for machine learning applications.

Analog In-Memory Computing (AIMC) has emerged as a promising alternative to the traditional Von-Neumann computing model. By executing computations directly within memory, AIMC mitigates the time and energy costs associated with data movement between processing units and memory (known as memory wall), resulting in more efficient systems. AIMC is viable for tasks with substantial data requirements, such as deep neural network (DNN) inference and optimization problems, which rely heavily on matrix-vector multiplication (MVM) operations.

Deep convolutional networks with residual connections are conventionally proposed as a solution to the problem of vanishing/exploding gradients in deep neural networks (DNN), which hinder convergence during gradient descent. Deep convolutional networks with residual connections (ResNets) mitigate the vanishing gradient problem by incorporating skip connections (skipping one or more layers), also known as shortcut or residual connections, enabling easier propagation of the gradients to earlier layers during backpropagation. The inclusion of skip connections in ResNets does not introduce extra parameters or additional complexity to the network. They enhance network accuracy with increasing depth, a notable contrast to networks lacking residual connections.

Residual connections are not limited to ResNets; they are also prevalent in various DNN architectures, such as transformers. In transformers, after each sub-layer—whether it is a multi-head self-attention mechanism or a position-wise fully connected (FC) feed-forward network—the output is added to its input, creating a residual connection, which is then followed by layer normalization.

### BRIEF SUMMARY

Principles of the invention provide techniques for efficient bits selection for arbitrary accumulation loops with minimal precision loss. In one aspect, an exemplary method includes the operations of computing a count of bits of a design of an accumulation register (a minimal size of the accumulation register) that ensures that a final accumulated value conforms to a specified precision and determining a sign extension parameter that defines a count of extension bits of the accumulation register; computing a count of most significant bits (MSBs) and a count of least significant bits (LSBs) to cut for each of a set of candidate steps (0, 1, . . . , K−1) of an accumulation loop; performing an accumulation of a given count of numbers for the accumulation register design; selecting a set of bits of the accumulation register design to output after completion of the performance of the accumulation operation based on the count of most significant bits (MSBs) and the count of least significant bits (LSBs); and instantiating an electronic circuit, the electronic circuit comprising a physical accumulation register that is configured to output the selected set of bits of the accumulation register design.

In one aspect, a computer program product comprises one or more tangible computer-readable storage media and program instructions stored on at least one of the one or more tangible computer-readable storage media, the program instructions executable by a processor, the program instructions comprising computing a count of bits of a design of an accumulation register (a minimal size of the accumulation register) that ensures that a final accumulated value conforms to a specified precision and determining a sign extension (SIGN_EXT) parameter that defines a count of extension bits of the accumulation register; computing a count of most significant bits (MSBs) and a count of least significant bits (LSBs) to cut for each of a set of candidate steps (0, 1, . . . , K−1) of an accumulation loop; performing an accumulation of a given count of numbers for the accumulation register design; selecting a set of bits of the accumulation register design to output after completion of the performance of the accumulation operation based on the count of most significant bits (MSBs) and the count of least significant bits (LSBs); and facilitating instantiation of an electronic circuit, the electronic circuit comprising a physical accumulation register that is configured to output the selected set of bits of the accumulation register design.

In one aspect, an electronic circuit comprises an accumulation register configured with a specified number of extension bits based on an estimated sign extension parameter, the sign extension parameter being based on a given count of accumulation operations; a truncation block configured to cut a specified set of bits of an output of the accumulation register; a counter configured to track of a count of accumulations that have been performed; demultiplexer configured to select an output of the demultiplexer coupled to an input of the accumulation register when an output of the counter is less than the given count of accumulation operations and to select an output of the demultiplexer coupled to an input of the truncation block when an output of the counter is not less than the given count of accumulation operations; an adder configured to add an input of the electronic circuit to a current value in the accumulation register during each accumulation operation, wherein the electronic circuit is configured to store a result of the adder in the accumulation register via the demultiplexer; and a comparator configured to change a selection of the demultiplexer when the count of accumulation operations equals the given count of accumulation operations to provide a final result from the accumulation register to the truncation block.

In one aspect, a hardware description language (HDL) design structure encoded on a machine-readable data storage medium, the HDL design structure comprising elements that when processed in a computer-aided design system generates a machine-executable representation of a semiconductor structure, wherein the HDL design structure comprises: an accumulation register configured with a specified number of extension bits based on an estimated sign extension parameter, the sign extension parameter being based on a given count of accumulation operations; a truncation block configured to cut a specified set of bits of an output of the accumulation register; a counter configured to track of a count of accumulations that have been performed; a demultiplexer configured to select an output of the demultiplexer coupled to an input of the accumulation register when an output of the counter is less than the given count of accumulation operations and to select an output of the demultiplexer coupled to an input of the truncation block when an output of the counter is not less than the given count of accumulation operations; an adder configured to add an input of the electronic circuit to a current value in the accumulation register during each accumulation operation, wherein the electronic circuit is configured to store a result of the adder in the accumulation register via the demultiplexer; and a comparator configured to change a selection of the demultiplexer when the count of accumulation operations equals the given count of accumulation operations to provide a final result from the accumulation register to the truncation block.

As used herein, “facilitating” an action includes performing the action, making the action easier, helping to carry the action out, or causing the action to be performed. Thus, by way of example and not limitation, instructions executing on a processor might facilitate an action carried out by semiconductor fabrication equipment, instructions executing on a remote processor, or the like by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
bit selection for arbitrary accumulation loops with minimal precision;
applicable in a broad spectrum of deep learning applications where residual additions or matrix-matrix multiplication (MMMs) operations and matrix-vector multiplication (MVM) operations (which may require partial sum accumulation) are utilized;
a hardware realization of portions of the disclosed algorithms that offers the capability to execute arbitrary-sized accumulation loops in-situ with minimal energy and area overhead while minimizing precision loss;
selection of the number of bits based on the number of accumulations performed while minimizing the precision loss and the amount of hardware resources required for a possible re-quantization step to address precision loss during intermediate stages of an accumulation operation, minimizing potential hardware overhead;
minimization of precision loss and enhancement of the accuracy and efficiency of the accumulation process;
elimination of the necessity for re-quantization (scale and offset) to achieve the desired precision; and
mitigating precision loss build up during end-to-end deep neural network (DNN) inference which might diminish the overall model accuracy.

These and other features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 is a high-level diagram of AIMC tiles and a merging of partial results of the tiles;

FIG. 2 illustrates the convolution operation along with its operands;

FIG. 3 illustrates the partial sum accumulation procedure on different dataflows on digital artificial intelligence (AI) accelerators, for OX|K dataflow with output stationarity and C|K dataflow with partial output stationarity;

FIG. 4 illustrates a first example of the selection of bits to output from an intermediate accumulation register, in accordance with example embodiments;

FIG. 5 illustrates a second example of the selection of bits to output from an intermediate accumulation register, in accordance with example embodiments;

FIG. 6 is a flowchart for determining the count of extension bits to incorporate, the count of MSBs to cut and the count of LSBs to cut, in accordance with example embodiments;

FIG. 7A is a block diagram of an example circuit for efficient bit selection on the output for arbitrary-sized accumulation loops, in accordance with example embodiments;

FIG. 7B is a block diagram of a second example circuit for efficient bit selection on the input for arbitrary-sized accumulation loops, in accordance with example embodiments;

FIG. 8 is a block diagram of an example circuit for post processing logic incorporating efficient bit selection for arbitrary-sized accumulation loops, in accordance with example embodiments;

FIG. 9 illustrates the application of the above principles to digital accelerators, in accordance with example embodiments;

FIG. 10 illustrates the application of the above principles to residual branch addition in digital accelerators, in accordance with example embodiments;

FIG. 11 illustrates the application of the above principles to AIMC accelerators to perform partial sum accumulation, in accordance with example embodiments;

FIG. 12 illustrates the application of the above principles to AIMC accelerators to perform residual branch addition, in accordance with example embodiments;

FIG. 13 illustrates the application of the above principles to 3D AIMC accelerators to perform partial sum accumulation, in accordance with example embodiments;

FIG. 14A illustrates the application of the above principles to AIMC accelerators to perform accumulation of different weight-set results where each tile can store multiple weight sets, in accordance with example embodiments;

FIG. 14B illustrates the application of the above principles to AIMC accelerators to perform partial sum accumulation on weight-sets where each tile can store multiple weight sets, in accordance with example embodiments;

FIG. 15A is a histogram of performance (measured with a mean absolute error (MAE) metric) of different cutting schemes for different numbers of accumulations, in accordance with example embodiments;

FIG. 15B is a histogram of performance (mean absolute error (MAE) metric) for different numbers of accumulations, in accordance with example embodiments;

FIG. 16A is a histogram of performance (mean absolute error (MAE) metric) for different numbers of accumulations, in accordance with example embodiments;

FIG. 16B is a histogram of performance (normalized mean absolute error (NMAE) metric) for different numbers of accumulations, in accordance with example embodiments;

FIG. 17A is a histogram of performance (mean absolute error (MAE) metric) for different numbers of accumulations, in accordance with example embodiments;

FIG. 17B is a histogram of performance (normalized mean absolute error (NMAE) metric) for different numbers of accumulations, in accordance with example embodiments;

FIG. 18 depicts a computing environment according to an embodiment of the present invention; and

FIG. 19 is a flow diagram of a design process used in semiconductor design, manufacture, and/or test.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

Given the prevalence of residual connections across various DNN models, it is advantageous to be able to perform an accumulation operation, involving the addition of layer outputs to their respective inputs.

### Analog In-Memory Computing (AIMC)

Leveraging its weight-stationary property, AIMC enables MVM operations to be executed with [symbol] (1) time complexity and prominent power efficiency. Utilizing the conductance values of memristive elements to encode matrix parameters and applying voltage pulses for input vector (activation) encoding enables the exploitation of Ohm's and Kirchhoff's laws to compute dot products through the measurement of resulting currents. The fundamental units of AIMC systems are AIMC tiles that typically include:
a crossbar (xbar) of memristive devices that encode the matrix elements (e.g., weights of DNN layers);
a series of digital-to-analog converters (DACs) that encode the input vector to voltage pulses, to be further applied to the crossbar; and
a series of analog-to-digital converters (ADCs) responsible for decoding the resultant current of the multiplication into output vectors.
   Performing Analog MVM with Large Matrices

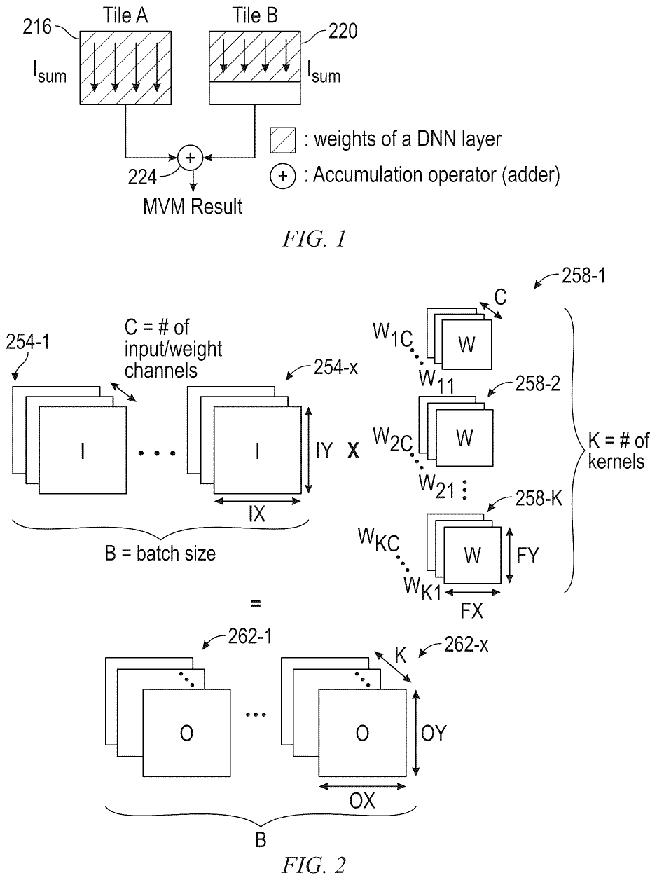

FIG. 1 is a high-level diagram of AIMC tiles and a merging of partial results of the tiles. In AIMC systems, it is typical for the size of the weight array to not perfectly match the dimensions of a single tile, such as tile 216 or tile 220, when mapping a DNN layer onto a single AIMC tile. If the weight array exceeds the dimensions of the crossbar in the input dimension (row), the layer should be split and be mapped across multiple tiles 216, 220. The partial results (partial sums) obtained from these multiple tiles should be accumulated (note accumulation operator 224) along the columns/bitlines to produce the final output. The accumulation of partial sums is a common occurrence in many analog MVM workloads; therefore, there are specialized units for performing accumulation within contemporary AIMC systems. In these systems, accumulation of partial results is typically done in one of the following ways:
data originating from a transmitting core (Tx core) is transmitted through a communication channel to a receiving core (Rx core), where accumulation occurs at the periphery by dedicated digital circuits; and
data from both the transmitting and receiving cores is routed through a communication channel to a specialized unit within the system; this unit is responsible for accumulation, storage, and propagation of data to the subsequent layer.

### MVM and Matrix-Matrix Multiplication (MMM) in Digital

Another common occurrence of partial sum accumulation is in the domain of digital artificial intelligence (AI) accelerators. These accelerators typically include single instruction multiple data (SIMD) units that include arrays of processing elements (PEs) that execute multiply-and-accumulate (MAC) operations. The weight mapping on the array can differ for matrix-matrix multiplications (MMMs) (used for convolutional neural networks (CNNs), deconvolution, temporal convolutional networks (TCNs), generative adversarial networks (GANs), and auto-encoders (AEs)) and MVMs (used for fully connected (FC), long short-term memory (LSTM), recurrent neural networks (RNNs), norm calculation of support vector machines (SVMs), and the like).

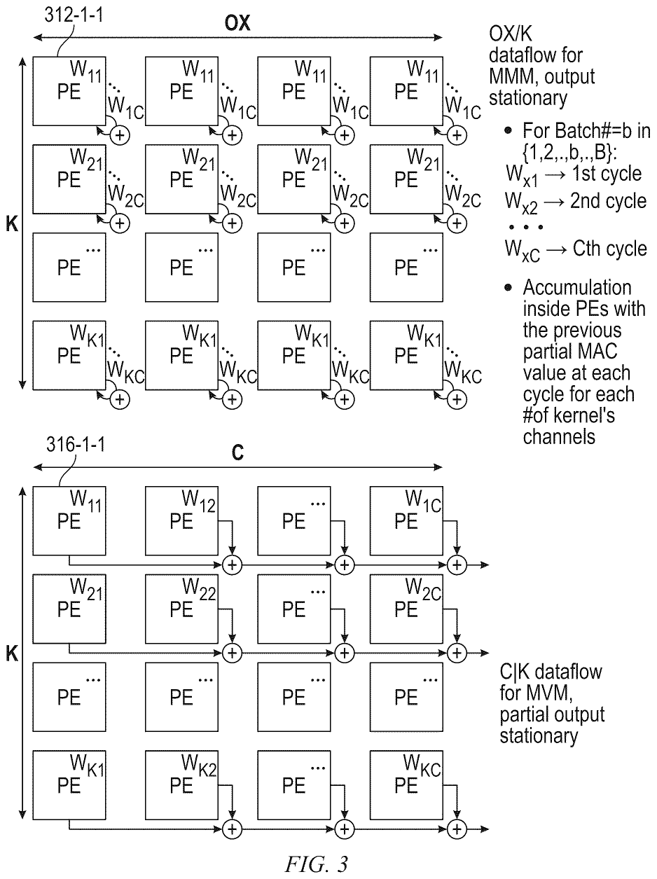

FIG. 2 illustrates the convolution operation along with its operands, detailing their respective size information. The input and weight channels are multiplied with convolutional kernels to produce the output channels. In FIG. 2, an example convolution operation is shown, including the operands with their respective size information. A single input channel/tensor I 254-1, 254-x has size of IX and IY, on x and y dimensions respectively. There are C of such channels within a single batch, where the total number of batch sizes is B. Each input channel is multiplicated with convolution kernels 258-1, 258-2, . . . , 258-K, with sizes FX and FY on the x and y dimension and a number of channels C, where there a total of K number of such kernels. The number of channels on the output 262-1, . . . , 262-x is equal to the number of convolutional kernels K, and the number of batches on the output 262-1, . . . , 262-x is equal to the number of input batches B. Each output matrix has a size of OX and OY, on x and y dimensions respectively, which depends on parameters such as input size, kernel size, stride (the step size with which the convolutional filter moves across the input tensor in the height and width dimensions), padding (the number of pixels, usually zeros, added to the edges of the input tensor) and dilation (the spacing between the elements of the kernel).

In MMMs, optimizing both data and weight (kernel) reuse, OX|K dataflow with output stationarity can be used, whereas in MVMs, C|K dataflow with partial output stationarity can be adopted, exploiting reuse of input spatial data.

### Accumulation in Digital Accelerators

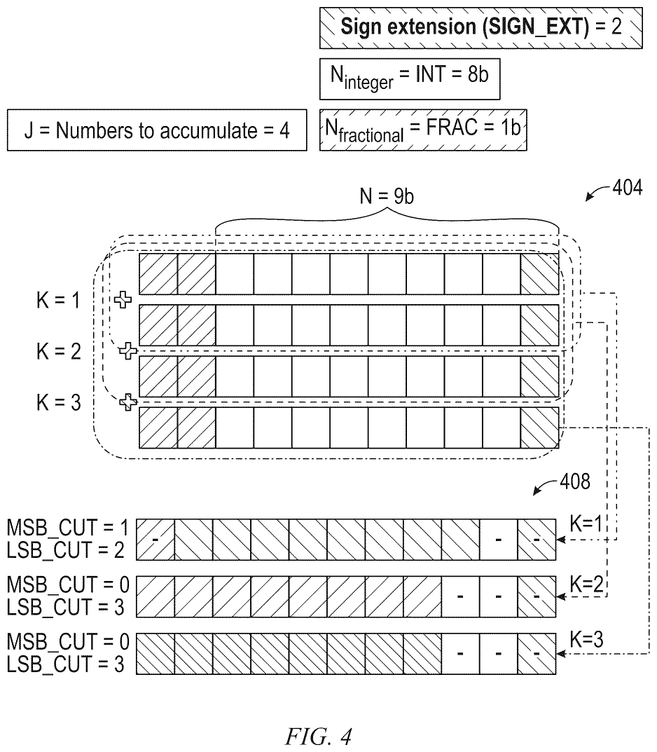

FIG. 3 illustrates the partial sum accumulation procedure on different dataflows on digital AI accelerators, for OX|K dataflow with output stationarity and C|K dataflow with partial output stationarity. In the OX|K dataflow scheme, spatial unrolling occurs along the OX and K dimensions, whereas the rest of the operations are temporally unrolled. The weights stored in each PE 312-1-1, 316-1-1 is altered with the subsequent channel within a single convolution kernel at different computation cycles as shown in FIG. 3 (top). The input activation data is multi-casted in the vertical direction, whereas the weights are multi-casted along each row. Due to output stationarity, the accumulation of partial results continues inside each processing element (PE) 312-1-1, 316-1-1 until the final output is obtained.

On the other hand, in C|K dataflow, C and K dimensions are spatially unrolled. The channels of a single convolution kernel are distributed across each row of the PE 312-1-1, 316-1-1, as shown in FIG. 3 (bottom). Each row of the PEs 312-1-1, 316-1-1 processes different input channels (C) for the same output channel (K). Therefore, when the PEs 312-1-1, 316-1-1 are done with MAC operations, the outputs of PEs 312-1-1, 316-1-1 per row typically must be accumulated using an adder tree. Subsequently, one final output per row is transferred to the activation memory. These processes underscore the significance of partial sum accumulation within digital AI accelerators.

The importance of enabling multiple accumulation operations within a single unit, ideally situated at the periphery of processing elements (PEs) 312-1-1, 316-1-1 dedicated to MVM or MMM tasks, such as an AIMC tile or a digital PE, has been highlighted above. Otherwise, these operations would typically necessitate dedicated digital processing cores, potentially leading to additional data movement and, consequently, increasing energy consumption and latency overhead. However, as the number of accumulations increases, maintaining the result's precision typically necessitates an increase in output bit width. Nevertheless, in multi-core systems, there is a drive to minimize output size to facilitate data movement in the system.

When the number of accumulations increases, it is a problem to keep a lower number of bits on the output due to evident precision loss and, in general, in state-of-the-art (SOTA) solutions, the common practice is to cut the least significant bits (LSBs), reducing the accuracy of DNNs, or applying re-quantization on the quantized partial sum before further accumulation, resulting in additional area and energy overhead.

Such digital processing units with accumulation logic typically must be designed to preserve high-precision as much as possible with minimal energy and area overhead; this necessitates exploration of quantization schemes to reduce the number of bits of the accumulated result while considering the mentioned constraints. These quantization schemes must also consider scenarios with an arbitrary sized accumulation loop, since all workloads might have different accumulation requirements.

### Conventional Systems

A variety of approaches exist for implementing accumulation logic to cater to diverse requirements, as documented in the literature. In digital AI accelerators, there are approaches where multiple partial sum accumulations are supported during MAC operations within a single PE. In such designs, a large bit-width register retains the accumulated partial sum in high precision until the completion of the accumulation operation, where such precision is reduced to the desired output's precision to optimize data movement. By embedding a large register within the arithmetic operation block, the overhead of moving large bit-width partial sums to an external memory is eliminated. To reduce the bit-width of the accumulated result, a common strategy is to employ re-quantization for the desired output's precision level. This can entail additional arithmetic operations, such as scaling factor multiplication and offset parameter addition.

There are also examples of heterogeneous architectures where an accumulation operation is supported in both AIMC tiles, as well as digital PEs within the same system-on-chip (SoC). AIMC tiles feature a Single Instruction Multiple Data (SIMD) unit at their periphery, capable of processing multiple input data streams in parallel. This SIMD unit is a multi-stage programmable pipeline, supporting various operations including partial sum accumulation, batch-norm operation, residual branch addition, a simple activation function (e.g., rectified linear unit (ReLU)), re-quantization, and pooling. However, a drawback of this approach is the need to fetch partial accumulation data or residuals from L1 memory whenever required, leading to increased latency and energy overhead. Additionally, intermediate accumulation results are downscaled to the selected precision of the system before being stored in L1 memory, resulting in precision loss that escalates with the number of accumulations performed.

In multi-tile systems within the AIMC domain, various approaches have been devised to facilitate accumulation operations. In one such approach, accumulation is performed in digital processing units situated at the periphery of each AIMC tile 216, 220. These units support the addition of two inputs (1 accumulation) in 16-bit floating point (FP16) precision.

However, to enable a greater number of accumulations (>1), the partial sum typically must be transferred to the periphery of another tile via the communication interconnects of the multi-tile system. This process introduces increased energy consumption and latency overhead. Moreover, when transferring data to the communication interconnects, the intermediate accumulation result's precision is reduced from FP16 to 8-bit integer (INT8) precision, resulting in a loss of precision.

There is another approach in multi-tier three-dimensional (3D) AIMC systems, devised to perform in-situ partial result accumulation within the ADCs (in-ADC accumulation), which are responsible for converting the analog MVM result into the digital domain. For instance, if the weight array is mapped to L tiers, there is a shared ADC at the periphery of a stack of tiers which is multiplexed sequentially during L MVM operations. An ADC counter continues its operation until all MVM operations are completed sequentially and accumulates the integrated current coming from each tier.

In the unoptimized version of in-ADC accumulation, B=K+log₂(L) bits are used in the counter register to hold the total results without precision loss, where K is the number of rows of the in-weight array, meaning this approach results in a large counter register size, resulting in significant area overhead.

In the second conventional approach for in-ADC accumulation, if the number of bits required to store the accumulation result is larger than a predefined size of a counter n (B>n), the number of pulses coming from sensing and conversion stages of the ADC are down-sampled with a frequency N_{down}=2^{(B-n)} or an optimized frequency found through test samples. This results in lower precision as the incoming numbers are quantized below their original size of K bits.

The in-situ partial result accumulation within ADCs is confined to the AIMC domain and lacks versatility for broader applications since it is designed specifically for in-ADC accumulation.

There are fundamentally two issues with the conventional accumulation implementations:
some of the existing accumulation methodologies reduce the number of bits during intermediate accumulation stages by keeping the upper selected number of bits and discarding the lower bits; and
such an approach can build up precision loss with the number of accumulations to perform, adversely affecting the accuracy of DNNs.

Some other conventional approaches that instead perform multiple in-situ accumulation loops in high-precision (having a high number of bits for intermediate representations) mitigate the mentioned precision loss during intermediate steps and address the precision loss that might emerge due to reduction of the output bits by applying re-quantization on the final sum, which may result in additional hardware resources and lead to area and energy overhead.

### Bits Selection for Arbitrary Accumulation Loops

Generally, techniques are disclosed for selecting the bits to output after an integer accumulation operation. The number of bits selected depends on the number of accumulations performed while minimizing the precision loss and the amount of hardware resources required for a possible re-quantization step. Knowing the maximum number of accumulations to perform within a system, exemplary methods offer, for each number of accumulations within the predefined range, a way to select which output bits to keep to minimize the precision loss. When the number of accumulations to be performed is less than the predefined maximum, it is typically meaningless to keep all the upper bits, since not all of them are used. Example algorithms allow the discarding of both upper bits that are not used and/or lower bits that, in some cases, contribute less to the final precision depending on the accumulation step. This is because, in binary representation of an integer, each bit's contribution to the value decreases exponentially with its position from the Most Significant Bit (MSB) to the Least Significant Bit (LSB), as LSBs correspond to smaller powers of 2.

In example embodiments, a method performs an accumulation of an arbitrary count of numbers in an accumulation register, whereby the bits to output from the accumulation register are pre-selected at configuration time depending on the count of numbers accumulated in order to minimize the precision loss. Additionally, special purpose fixed-point based hardware circuitry implements a disclosed selection methodology. This hardware enables maintaining the precision on the output of an accumulation by statically determining which bits to output and, at the same time, minimizing the required hardware resources that might be necessary to restore the precision.

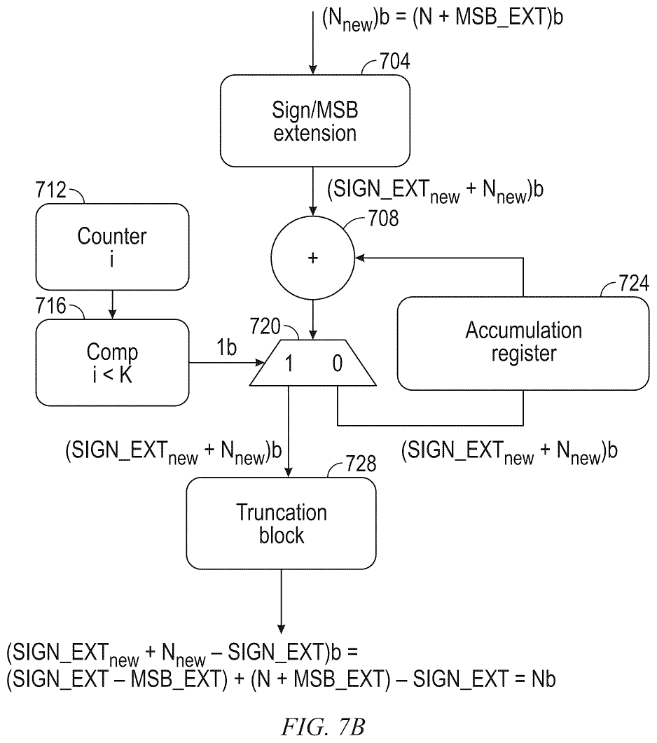

Example embodiments can be applied in a broad spectrum of deep learning applications where residual additions or MMMs/MVMs (which may require partial sum accumulation) are utilized. A hardware realization of the disclosed algorithm, as illustrated, for example, in the embodiment of FIG. 7A, offers the capability to execute arbitrary-sized accumulation loops in-situ with minimal energy and area overhead while minimizing precision loss.

Efficient Bits Selection Method for Arbitrary Accumulation Loops with Minimal Precision Loss Steps

In example embodiments, a user defines (via, for example, a user interface) the maximum number of accumulations (K) to perform, the size of the inputs (such as N_int+N_frac), and the size of the output (N_out≥N_int). In example embodiments, a software-based algorithm uses the parameters to compute:
the sign extension (SIGN_EXT) which defines the minimal size of the intermediate accumulation register required to represent the accumulation result (SIGN_EXT+N_int+N_frac) without precision loss; and
the most significant bits (MSBs) and the least significant bits (LSBs) to cut for each of the possible steps (0, 1, . . . , K−1) in the accumulation loop to minimize the precision loss at each step.

The algorithm outputs the SIGN_EXT parameter and two lists: one for the MSBs to cut at each step and one for the LSBs to cut at each step.

The outputs of the algorithm can be sent as an input to parametric hardware circuitry, together with the number of bits of the input, the number of bits of the output and the maximum number of accumulations. The hardware circuit uses the output of the algorithm, i.e, the MSB and LSB lists, to select which bits of the intermediate accumulation register to output depending on the number of accumulations effectively performed.

### Embodiment Descriptions

Exemplary embodiments introduce a dynamic method for selecting output bits based on the number of accumulations to be performed, in contrast to conventional techniques which only allow either retaining the upper bits or applying re-quantization to meet the output precision level. By dynamically adjusting the bit selection, this method minimizes precision loss and enhances the accuracy and efficiency of the accumulation process.

In example embodiments, a bit selection method dynamically selects which bits to output for the final accumulation result with minimal precision loss depending on the number of accumulations to perform, eliminating the necessity for re-quantization (scale and offset) to achieve the desired precision. The exemplary bit selection method offers the capability to execute arbitrary-sized accumulation loops in-situ with minimal energy and area overhead.

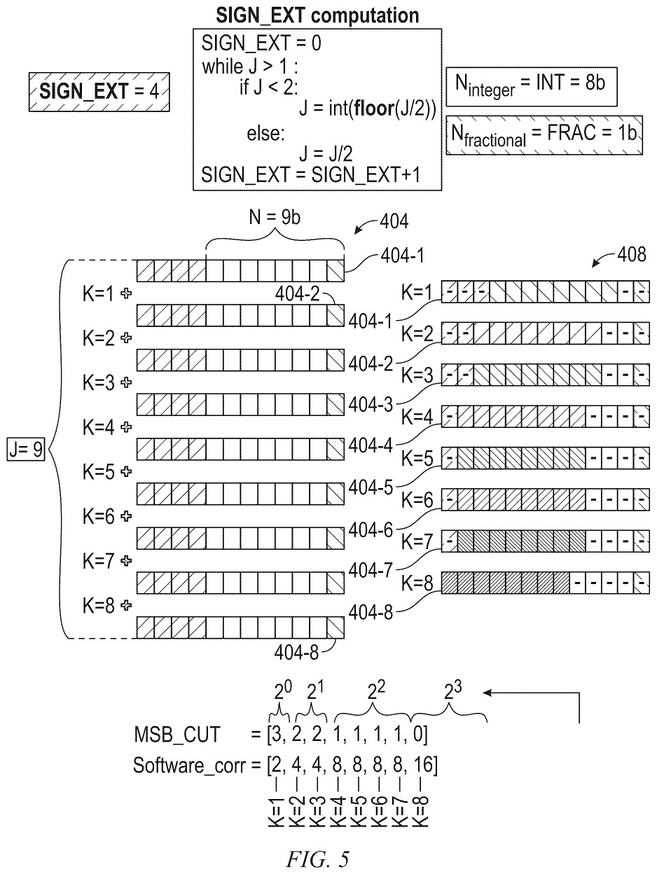

FIG. 4 illustrates a first example of the selection of bits to output from an intermediate accumulation register, in accordance with example embodiments. In the example of FIG. 4, the input is a fixed-point number of nine bits (an integer section of 8 bits and a fractional portion of 1 bit) and a maximum number of accumulation iterations 404 (K=3). A sign extension SIGN_EXT of two bits is included in the intermediate accumulation register to represent the final accumulated value without any arithmetic overflow during intermediate accumulation steps.

In example embodiments, a method properly selects the important bits 408 to keep for the output of an accumulation operation depending on the number of times the accumulation is performed, while keeping the precision loss as low as possible. The purpose is to accumulate Nb signed integer/fixed-point numbers (N_{integer}+N_{fractional} precision) for a total of K-times (with a maximum of J numbers to be accumulated, where J=K+1) using a high precision of N+(SIGN_EXT)b, and output again an (N−N_{fractional})_{b} signed integer/fixed-point number while ensuring minimal precision loss and minimal accuracy loss by properly selecting the bits to keep and, if needed, adjusting them in software to compare the adopted methodology with FP16 numbers. As illustrated in FIG. 4, in the described scenario, if only one iteration is performed, the MSB and two LSBs are cut. If two or three iterations are performed, the 3 LSBs are cut.

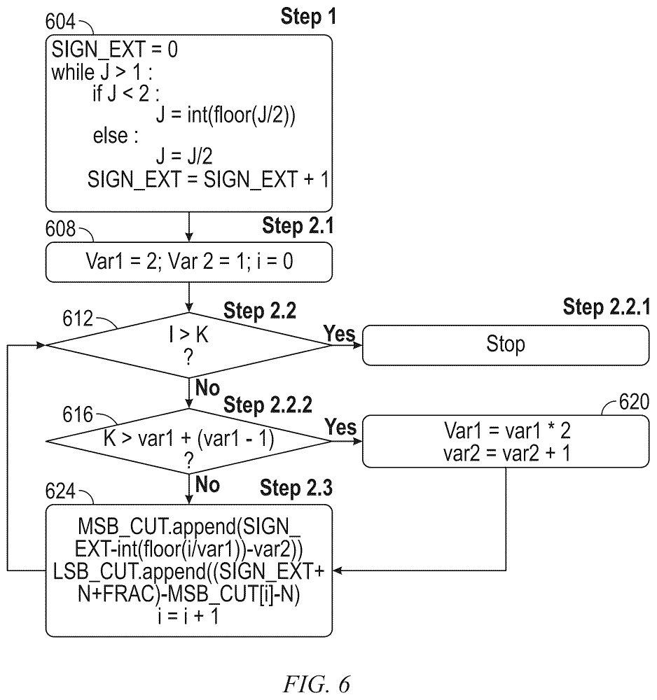

FIG. 5 illustrates a second example of the selection of bits to output from an intermediate accumulation register, in accordance with example embodiments. The SIGN_EXT computation determines the count of extension bits to use based on the maximum number J of numbers to be accumulated 404. As illustrated in FIG. 5, J=9, the input is nine bits and the output is eight bits. Four extension bits are included in the intermediate accumulation register. If one iteration is performed, the three MSBs and two LSBs are cut at 404-1. If two or three iterations 404-2, 404-3 are performed, the two MSBs and three LSBs are cut. If four to seven iterations 404-4, 404-5, 404-6, 404-7 are performed, one MSB and four LSBs are cut. If eight iterations are performed, the five LSBs are cut.

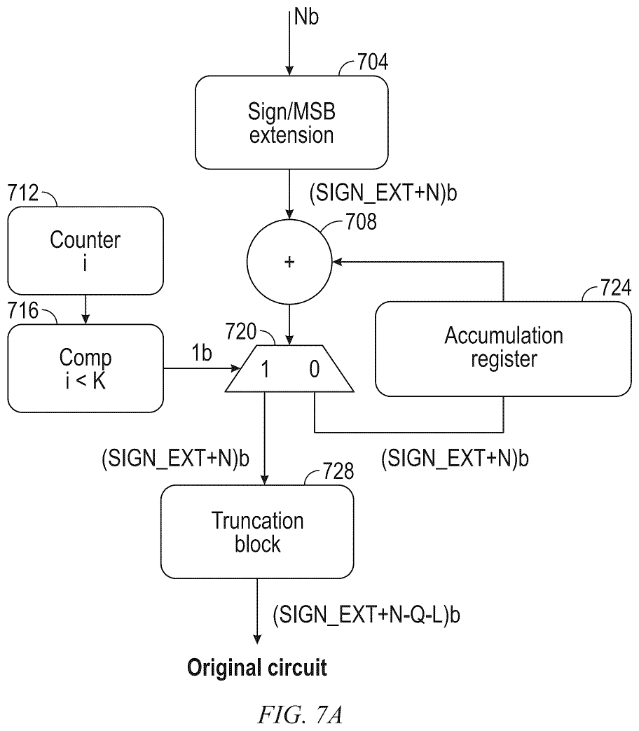

FIG. 6 is a flowchart for determining the count of extension bits to incorporate, the count of MSBs to cut, and the count of LSBs to cut, in accordance with example embodiments. In example embodiments, the algorithm starts by computing the number of bits required by the accumulator register to ensure that the final accumulated value includes the full information (specified precision). This step includes computing the sign extension (SIGN_EXT) parameter (operation 604) that is summed to the number of bits of the input (Nb) to define the accumulator register size (N+SIGN_EXT).

The number of MSBs and LSBs to cut is computed depending on the accumulation step (K). This is done using two variables: var1 and var2. Variable var1 is initialized to two, variable var2 is initialized to one, and a counter i is initialized to zero (operation 608). A check is performed to determine whether the counter is greater than the number of accumulations to perform (K) (decision block 612). If the counter is greater than the number of accumulations to perform (K) (YES branch of decision block 612), the method ends.

If the counter is not greater than the number of accumulations to perform (K) (NO branch of operation 612), a check is performed to determine whether K is greater than (var1+ (var1−1)) (decision block 616). If K is greater than (var1+(var1−1)) (YES branch of decision block 616), the variables are increased based on var1=var1*2 and var2=var2+1 (operation 620) and the method proceeds with operation 624; otherwise (NO branch of decision block 616), the method proceeds with operation 624.

During operation 624, the MSBs and LSBs to cut are defined based on MSB_CUT.append(SIGN_EXT−int(floor(i/var1))−var2) and LSB_CUT.append((SIGN_EXT+N+FRAC)−MSB_CUT[i]−N), the counter i is incremented, and the method proceeds with decision block 612. The algorithm is based on average accumulation behavior expected from random input combinations.

### Embodiment 1—Accumulation Hardware Circuit

FIG. 7A is a block diagram of an example circuit for efficient bit selection on the output for arbitrary-sized accumulation loops, in accordance with example embodiments. An exemplary bit selection method can be implemented in hardware through a digital circuit with minimal area and latency overhead. In example embodiments, the input is a signed/unsigned integer/fixed-point N-bit input. In example embodiments, an accumulation register 724 is configured with a specified number of extension bits (based on the estimated SIGN_EXT parameter; see FIG. 6) (block 704). In example embodiments, the block 704 is a sign-extension circuit which can be implemented by simply routing the MSB wire of the input to all the higher-order bit positions defined by SIGN_EXT parameter. During each iteration, the input is added to the current value in the accumulation register 724 using an adder 708 and the result is stored in the accumulation register 724 via demultiplexer 720. A counter 712 keeps track of the number of accumulations that have been performed (K∈[0,J]). When the count of iterations reaches the desired count K, a comparator 716 changes the selection of the demultiplexer 720 to provide the final result in the accumulation register 724 to a truncation block 728. The truncation block 728 cuts the appropriate count of MSBs (Q) and LSBs (L) (depending on K) as defined by the list for the MSBs and the list for the LSBs, respectively, to cut at each step, where Q=MSB_CUT[K−1] and L=LSB_CUT[K−1]. Since the size of parameters is fixed in hardware, MSB_CUT[0:J−2] and LSB_CUT[0:J−2] can be stored as internal parameters, eliminating the need for additional logic to compute them.

### Embodiment 2—Post Processing Logic with Accumulation Support in AIMC

AIMC accelerators typically require some additional digital post-processing (referred to as an “affine correction” operation) of the output data to compensate for non-idealities and circuit mismatches of memory devices and ADCs, respectively. To comply with AIMC energy efficiency and latency, the ideal solution is to place one of these digital blocks per crossbar column. However, the pitch of the devices per column, e.g., Phase Change Memory (PCM), limits the available area for such logic. Consequently, a small, fast and energy-efficient digital block must be designed for the post-processing operations. Conventional implementations of such post-processing block adopting fixed-point precision computations has been presented in the literature.

Such a post-processing block can be complemented with a digital circuit version of an exemplary bit selection method to support accumulation directly on the periphery of the AIMC, minimizing data movement and improving latency compared to moving all the data to perform the accumulation in a different block in the system. These digital post-processing units with accumulation support can be placed multiple per AIMC crossbar and can be time-multiplexed across different columns of a crossbar.

In example embodiments, an exemplary bit selection method is integrated in the accumulation circuitry to properly select the output bits depending on the number of accumulations performed, given the maximum number of accumulations pre-defined for the circuit. The size of the input parameters is determined by the output of the affine correction operations, while the output size is determined by the precision required for activations in DNNs adopted by the AIMC system.

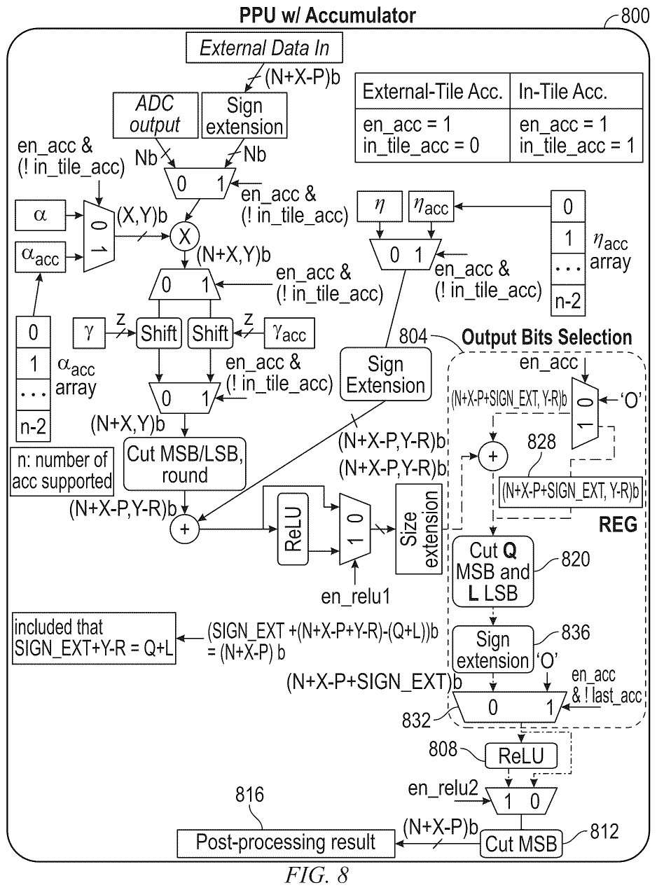

In post-processing logic for AIMC, the input to exemplary algorithms that corresponds to the values to accumulate is the output of the affine-correction procedure and includes a fixed-point precision value. Such value is made of N+X-P bits for the integer part and Y-R bits for the fractional part (the input to the output bits selection circuit 804 in FIG. 8 from the left). N is the output precision of the ADCs, (X,Y) is the fixed point representation of affine correction scale parameter where X corresponds to the number of integer bits, Y corresponds to the number of fraction bits in such a representation, and P and R correspond to the number of bits to truncate from the MSB and LSB side, respectively, after performing affine correction to comply with the bit-width adopted by the communication interconnects of the system.

After the affine correction, the data is stored in the register (REG) with sufficient precision to support a maximum number of accumulations that is predefined during the design step and is taken into consideration by the parameter SIGN_EXT. After storing the data in the register (REG), this can be used as an input to the accumulator. In this way, the accumulation can be performed between the value stored in the register (REG) and a new value coming from the output of the affine correction. This step is repeated until all the desired number of accumulations (K) is achieved and the last accumulation is performed. The number of accumulations (K) is a number between 0 and the maximum number of accumulations (J−1) supported by the circuit.

During these accumulation steps, an exemplary bit selection method is not performing any MSB or LSB cut. This is done to be able to keep a high level of precision for the accumulated values. Once the last accumulation is achieved, the disclosed circuit will cut Q MSBs and L LSBs depending on the number of accumulations (K) performed, where Q and L are computed with the disclosed bit selection methods, as described above.

### Embodiment 3—Software/Hardware Co-Design: Input Operands Size Selection Based on an Error Metric

The exemplary bit selection methods can be used for software/hardware co-design purposes. For instance, there can be a certain threshold for the selected error metric, e.g., a mean absolute error (MAE) metric for the desired application and the maximum number of accumulations to be performed (J−1) in the design.

In example embodiments, the algorithm can be run for various numbers (i) of input bit-widths (Nb) for all possible accumulation loops (J−1) and the MAE metric can be calculated for each combination (For N={N₁, N₂, . . . , Nᵢ}, and J={0, 1, . . . , J−1}). Then, the minimum input bit size that yields the MAE values that are all under the predefined threshold can be selected (N with MAE<threshold for J={0, 1, . . . , J−1}). Therefore, with this exemplary algorithm, the minimum number of bits that ensures that all accumulation loops will yield a MAE less than a defined threshold can be defined. This number of bits can then be used to define the accumulation register size for the accumulator to minimize the precision loss during the accumulation loop. The exemplary algorithm can be performed for several candidate input bit widths and the minimum bit width that produces an output below the error threshold for all accumulation steps can be selected for the design.

### Embodiment 3—Software/Hardware Co-Design: Input Operands Size Selection Using the Disclosed Algorithms

The bit selection methods can be used for software/hardware co-design purposes where the input bit-widths can be selected with the exemplary techniques to perform high-precision accumulation depending on the number of accumulations to be performed. FIG. 7B is a block diagram of a second example circuit for efficient bit selection for an arbitrary-sized accumulation loop, in accordance with example embodiments. The design with updated operand bit-widths of FIG. 7B can be implemented in hardware through a digital circuit, similar to the circuit of FIG. 7A, with minimal area and latency overhead. The signed/unsigned integer/fixed-point N_{new}=N+MSB_EXT bits input (MSB_EXT is calculated in the same way as MSB_CUT, as described above); a sign/MSB extension of the input based on the previously estimated SIGN_EXT parameter and the new MSB_EXT: SIGN_EXT_{new}=SIGN_EXT (as defined above) −MSB_EXT. Since the size of parameters is fixed in hardware, MSB_EXT [0:J−2] can be stored as an internal parameter, eliminating the need for additional logic to compute them.

For instance, when performing only one accumulation, a larger input operand size can be used since there will be more precision in the system. Here, the truncation block does not implement the algorithm, but is just cutting the LSBs because the MSBs are being used to increase the precision of the accumulation scheme. For example, the input operand size might be decreased to 8 bits to perform accumulations, but the algorithm on the input size may not be decreased to 8 bits, but may be kept at 10 bits. Because a fewer number of accumulations are going to be applied anyway, then only the LSBs are cut at the end of the truncation block, and the information is kept in the MSBs. Instead of keeping the middle region where it has useful bits, the numbers are being forced to use all of the bits, even the MSBs, even though normally they would not be used. Thus, the number of input bits used can be increased by introducing the MSB extension bits depending on the accumulation loops being performed. To take advantage of this technique, the number of input bits should increase to make it effective.

### Embodiment 4—Parametric Nature of the Algorithm

The exemplary bit selection methods can be parametric in terms of multiple aspects. The different parametric changes and their implementations have been explored individually.

Aspects that are presented include:
parametric bit-width of the operands;
parametric maximum number of accumulations; and
parametric accumulation register size.

### Parametric Bit-Width of the Operands

The exemplary bit selection methods are parametric in terms of the bit-width of the operands (values to accumulate). Having a parametric bit-width of the operands allows the adaptation of the exemplary algorithms for different applications where the bit-width of the operands to accumulate might change. In this case, the higher the bit-width of the operands, the higher the size of the accumulation registers. The steps of the algorithm are the same as FIG. 6. The algorithm is based on average accumulation behavior expected from random input combinations.

### Parametric Maximum Number of Accumulations

The exemplary bit selection methods are parametric in terms of the maximum number of accumulations. This means that the maximum number of accumulations can go from 0 to K (or J−1). Having a parametric maximum number of accumulations allows the adaptation of the exemplary algorithms for different applications where the number of accumulations might change. For example, in some instances of residual branch addition, the output of two layers should be summed, i.e., 1 accumulation; in partial sum accumulation instead, even 4 or more accumulations might be needed. The steps of the algorithm are the same as FIG. 6.

### Parametric Accumulation Register Size

The exemplary bit selection methods are parametric in terms of the accumulation register size. The accumulator register size does not necessarily need to be determined with the SIGN_EXT parameter (as defined above) and the input bit-size, but it can be kept as a design choice to accommodate for potential additional accumulation loops. Then, the new sign extension parameter, which is called SIGN_EXT_FINAL herein, can be defined with the following expression to ensure the parametric accumulation register size possibility is covered:

$$SIGN\_EXT \_FINAL = BIT\_WIDTH \_ACC \_REG - N$$

where, the parameters N and BIT_WIDTH_ACC_REG, correspond to:
N: bit width of a signed/unsigned integer/fixed-point input; and
BIT_WIDTH_ACC_REG: bit width of the accumulation register (by design choice).

The steps of the algorithm can be updated with the following steps:

The algorithm starts by computing the number of bits required by the accumulator register to ensure the final accumulated value includes the full information (specified precision). This step includes computing the sign extension (SIGN_EXT_FINAL) parameter (using the updated formula above) that is summed to the number of bits of the input (Nb) to define the accumulator register size (N+SIGN_EXT_FINAL).

The second step consists in computing the number of MSBs and LSBs to cut depending on the accumulation step (K). This is done with the help of two variables (var1 and var2). Variables var1 is initialized to two, var2 is initialized to one and a counter i is initialized to zero. A check is performed to determine whether the counter is greater than the number of accumulations (K) to perform (operation 612). If the counter is greater than the number of accumulations (K) to perform (YES branch of decision block 612), the method ends.

If the counter is not greater than the number of accumulations (K) to perform (NO branch of operation 612), a check is performed to determine whether K is greater than (var1+ (var1−1)) (decision block 616). If the K is greater than (var1+ (var1−1)) (YES branch of decision block 616), the variables are increased based on var1=var1*2 and var2=var2+1 (operation 620) and the method proceeds with operation 624; otherwise (NO branch of decision block 616), the method proceeds with operation 624.

During operation 624, the MSBs and LSBs to cut are defined based on MSB_CUT.append(SIGN_EXT_FINAL−int(floor(i/var1))−var2) and LSB_CUT.append((SIGN_EXT_FINAL+N+FRAC)−MSB_CUT[i]−N), the counter i is incremented, and the method proceeds with decision block 612. The algorithm is based on average accumulation behavior expected from random input combinations. Note: the number of bits of the accumulation register should be greater than the number of bits of the input.

FIG. 8 is a block diagram of an example PPU circuit 800 for post processing logic incorporating efficient bit selection for arbitrary-sized accumulation loops, in accordance with example embodiments. After the initial processing results are produced, an output bits selection circuit 804 selects the set of bits to output from the PPU circuit 800. Q MSBs and L LSBs are cut using cut circuit 820.

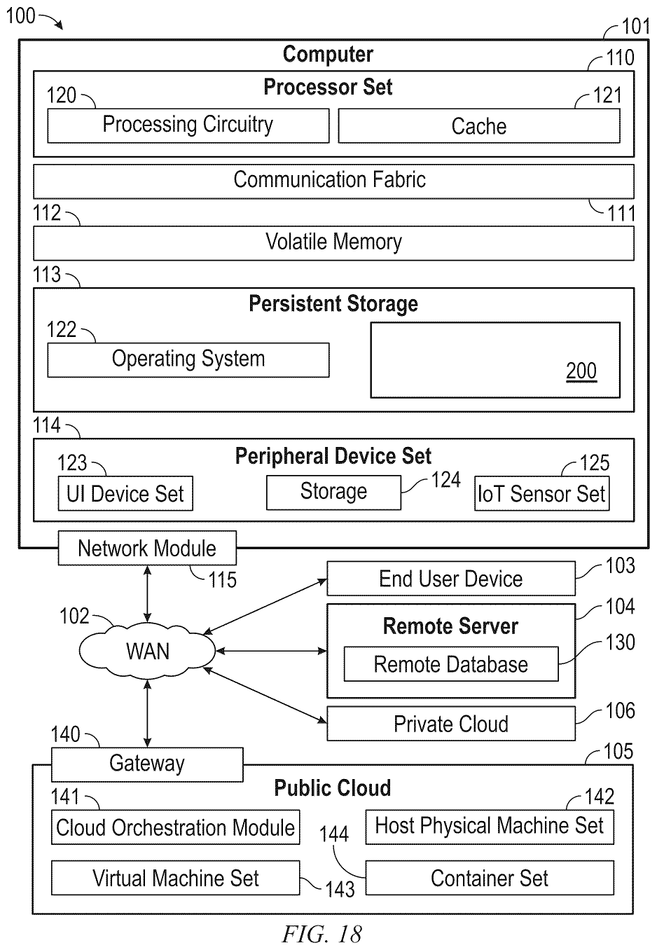

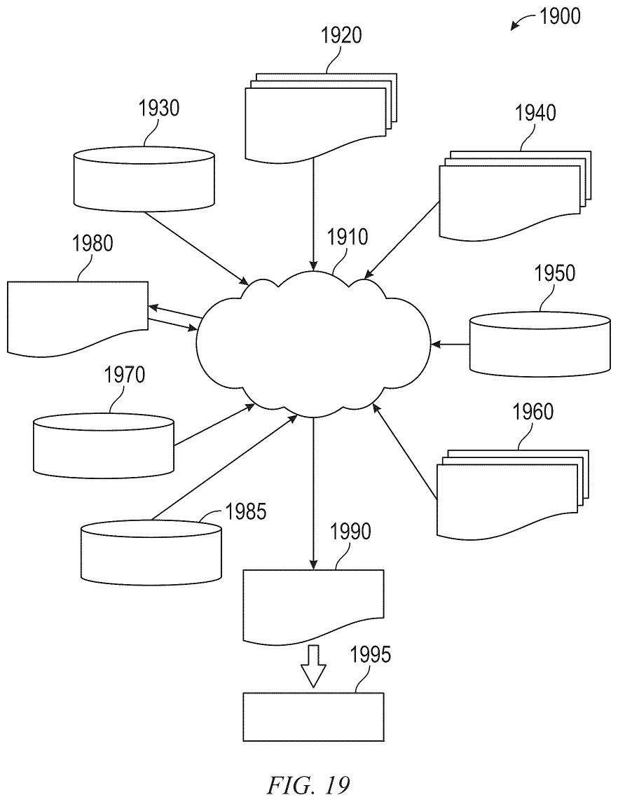

As illustrated in FIG. 8, the accumulation register 828 has a size that is equal to the bit-width of the input operands ((N+X−P+SIGN_EXT, Y−R)b). Using the multiplexer 832, when accumulation is being performed (that is, when the condition (en_acc &!last_acc)==1), the block outputs zero since the accumulation operation is not completed yet. When accumulation is not being performed (when only a simple affine correction operation is performed) or when the last accumulation stage/loop is being performed (that is, when the condition (en_acc &!last_acc)==0) Q MSBs and L LSBs are cut (cut block 820) and a sign extension 836 is performed. In example embodiments, a ReLU function 808 may be selectively performed prior to output of the selected set of bits. The appropriate MSBs are cut (using cut circuit 812) and the post-processing result 816 is output. The skilled artisan will be familiar with shift registers, multiplexers, demultiplexers, adders, storage registers, ReLUs (rectified linear units) and concatenators, and can use techniques such as are discussed with respect to FIG. 19 to instantiate the PPU circuit 800. Indeed, generally, structures as described herein can be designed, synthesized, and fabricated as described below with respect to FIG. 19; for example, using computer-aided technique with the aid of a general purpose computer such as described in FIG. 18.

### Embodiment 5—Partial Sum Accumulation in Digital Accelerators

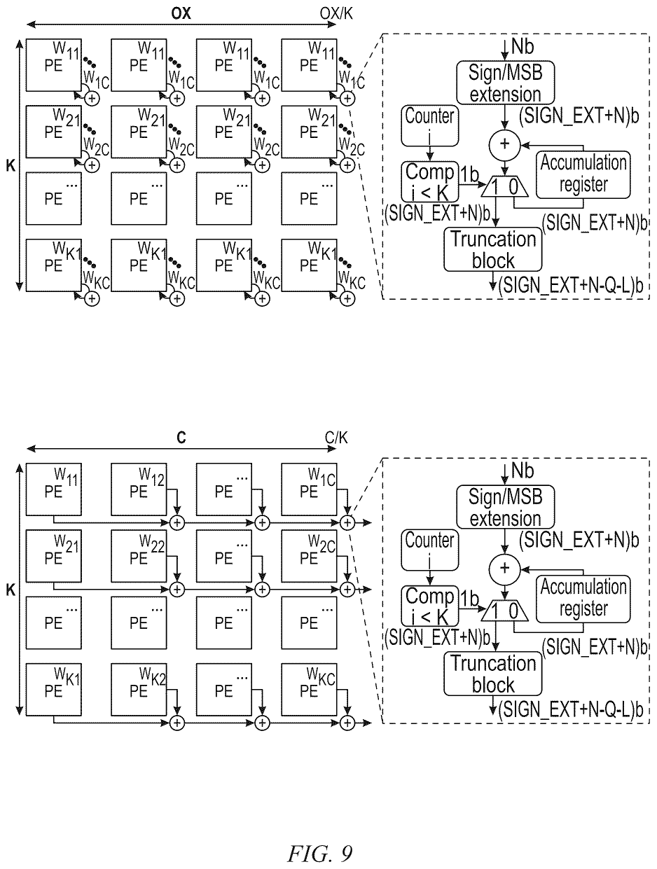

FIG. 9 illustrates the application of the above principles to digital accelerators, in accordance with example embodiments. The hardware implementation presented in FIG. 7A can be adopted in digital MVM accelerators, where the intermediate accumulation representation is kept in a larger bit-width using the SIGN_EXT parameter, depending on the desired maximum number of accumulations to be performed.

In the output stationary dataflow (OX|K), each PE is computing one element of the output matrices, and it is performing partial sum accumulations until the final output element is obtained. At this step, the disclosed algorithms can be adopted to select a desired number of bits on the output element that ensures a minimal precision loss depending on the number of accumulations performed. As a consequence, the disclosed circuit can be integrated in each PE.

In the partial output stationary flow (C|K), each row of PEs processes different input channels for the same output channel and the outputs of PEs per row should be accumulated using an adder tree. In this case, the exemplary bit selection methods can be adopted on the output of each adder tree to select a desired number of bits on the output element that ensures a minimal precision loss depending on the number of accumulations performed.

### Embodiment 6—Residual Branch Addition in Digital Accelerators

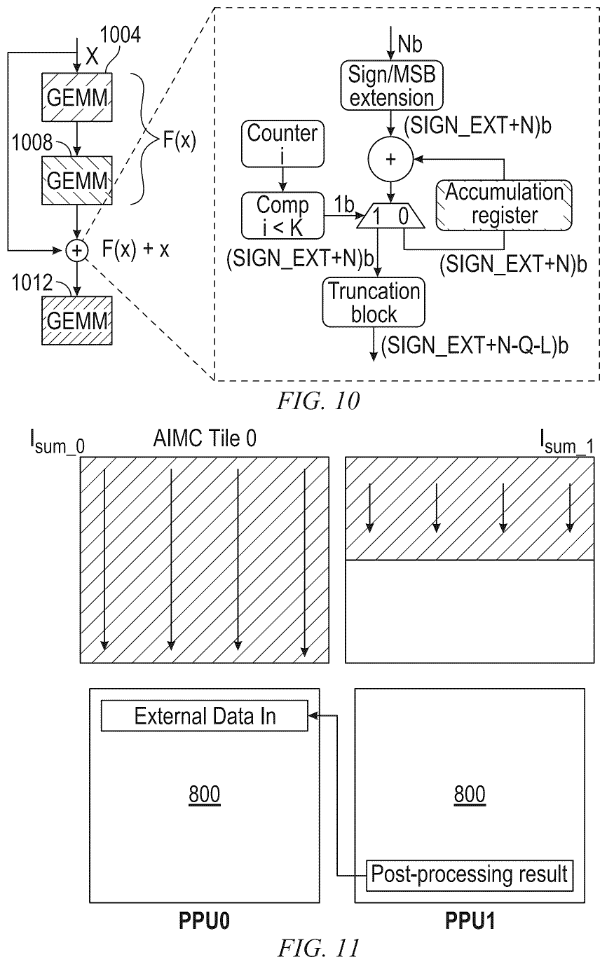

FIG. 10 illustrates the application of the above principles to residual branch addition in digital accelerators, in accordance with example embodiments. The hardware implementation presented in FIG. 7A can also be adopted in the context of digital accelerators to perform residual branch addition. In this case, the output of two different layers that are connected by a residual branch can be added in the digital domain. The output value is generally stored in a high-precision accumulation register.

In this context, the exemplary algorithms can be implemented in a digital circuit and can be integrated into a digital accumulator. Such a circuit can be used to efficiently select the output bits to keep for the output data that need to be transferred to the next digital accelerator. As depicted in FIG. 10, general matrix to matrix multiplication units 1004, 1008, 1012 sequentially process an input X. By employing the disclosed algorithm, a reduced number of bits can be selected for the output data that, in general, require lower precision during transmission to improve data movement.

In one or more embodiments, the accumulations are performed with enough precision to support a maximum number of accumulations that is predefined during the design step and is taken into consideration by the parameter SIGN_EXT.

After storing the data into the register (REG), the data can be used as an input to the accumulator. In this way, the accumulation can be performed between the value stored in the register (REG) and a new value coming, for example, from another accelerator or from memory. This step is repeated until all the desired number of accumulations (K) is achieved and the last accumulation is performed. The number of accumulations (K) can be a number between 0 and the maximum of number of accumulations (J−1) supported by the circuit. In this specific case, K=2.

During these accumulation steps, the exemplary bit selection method is not performing any MSB or LSB cut. This is done to keep high-precision for the accumulated values. Once the last accumulation is achieved, the disclosed circuit will cut Q MSBs and L LSBs depending on the number of accumulations (K) performed (in this case 2) where Q and L are computed with the exemplary bit selection methods.

### Embodiment 7—Partial Sum Accumulation Using Distinct AIMC Tiles

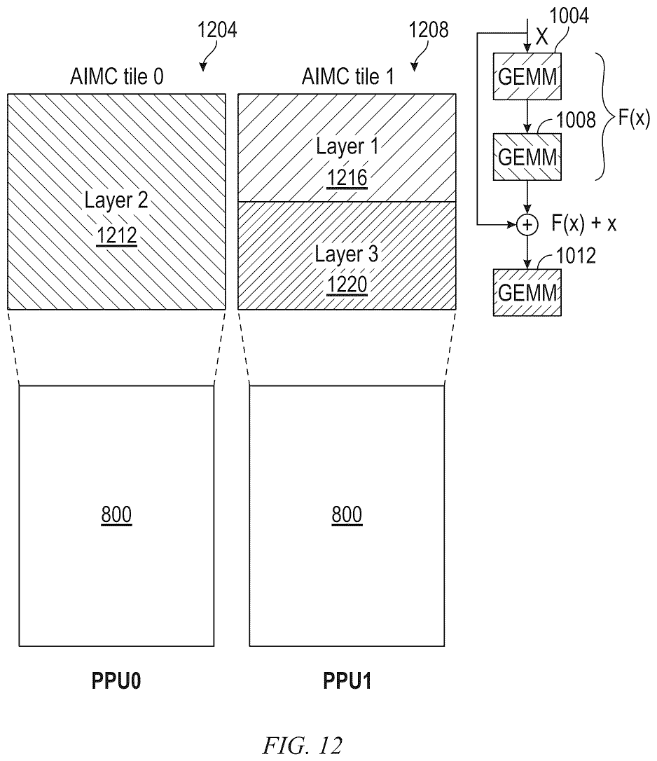

FIG. 11 illustrates the application of the above principles to AIMC accelerators to perform partial sum accumulation, in accordance with example embodiments. The post processing unit presented in FIG. 8 can be adopted in AIMC accelerators for cases where the size (in particular, the number of rows of the weight matrix) of the layer to map in the AIMC tile is larger than the number of rows available in the AIMC crossbar. In this case, the layer weights can be split into two or more different AIMC tiles and the resulting outputs can be accumulated column-wise (I_{sum_0}+I_{sum_1}) in some digital block.

The exemplary bit selection methods can be implemented as an extension to the AIMC tile post-processing logic, as shown in FIG. 8 and can be used to perform the partial sum accumulation of the outputs of the different tiles involved in the computations (using the External Data In data path in FIG. 11). In this case, only one of the post-processing units (PPUs) with the accumulation flow will be active and will receive the inputs to accumulate to the affine corrected output from the adjacent tile. For example, after performing affine correction, PPU1 can send the output to PPU0 which performs the accumulation. In this way, the partial sum accumulation is performed in a larger bit-width using the SIGN_EXT parameter, depending on the desired maximum number of accumulations (K) to be performed. Then, once all the desired number of accumulations is performed and the last accumulation is achieved, the disclosed circuit will cut Q MSBs and L LSBs depending on the number of accumulations (K) performed, where Q and L are computed with the disclosed bit selection methods.

### Embodiment 8—Residual Branch Addition in AIMC

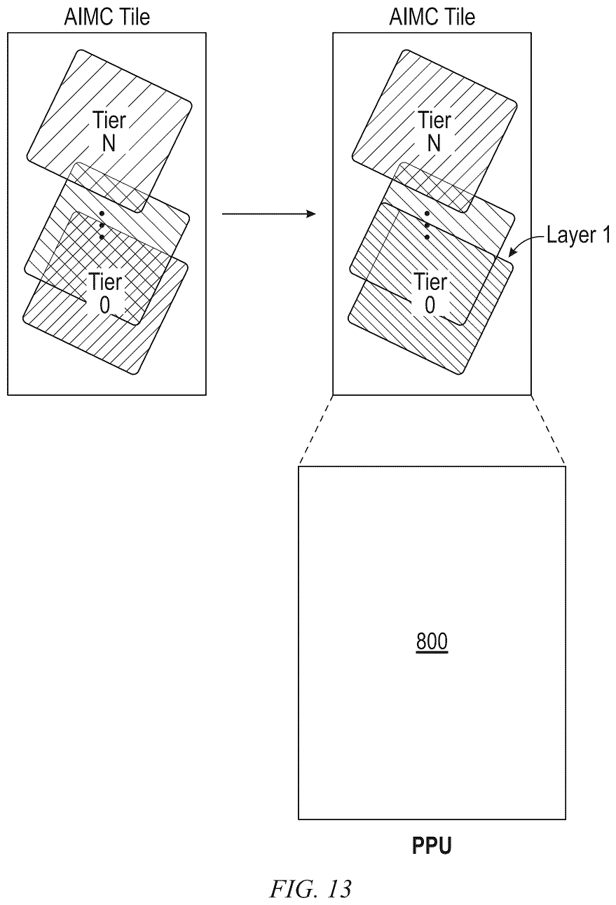

FIG. 12 illustrates the application of the above principles to AIMC accelerators to perform residual branch addition, in accordance with example embodiments. In this case, the weights of different layers can be mapped in different tiles (e.g., Layer 1 1216 and Layer 2 1212) or, if the size of the layers is small enough, multiple layers can be placed in different rows of the same tile (e.g., Layer 1 1216 and Layer 3 1220). The exemplary bit selection methods can be implemented as an extension to the AIMC tile post-processing logic, as shown in FIG. 8 and can be used to perform the residual branch addition on the outputs of the different tiles 1204, 1208 involved in the computations. In this case, the post-processing unit (PPU) with the accumulation flow receives as inputs the affine corrected output from its own tile or from the adjacent tile depending on which steps are being performed. For example, in FIG. 12:

PPU1 first performs affine correction for the output of Layer 1 1216 and sends them to AIMC tile 0 1204 that performs Layer 2 GEMM; and

PPU0 performs affine correction for the output of Layer 2 1212 and then accumulates the output results with the inputs of Layer 1 1216 in high precision and then reduces the precision through the disclosed bit selection methods before sending the accumulated output to AIMC tile 1 1208 which performs the GEMM for Layer 3 1220.

In this way, the residual branch addition is performed in a larger bit-width using the SIGN_EXT parameter, depending on the desired maximum number of accumulations (K) to be performed. Then, once all the desired number of accumulations are performed and the last accumulation is achieved, the exemplary circuit will cut Q MSBs and L LSBs depending on the number of accumulations (K) performed, where Q and L are computed with the disclosed bit selection methods.

### Embodiment 9—Partial Sum Accumulation Using Distinct Tiers in 3D AIMC

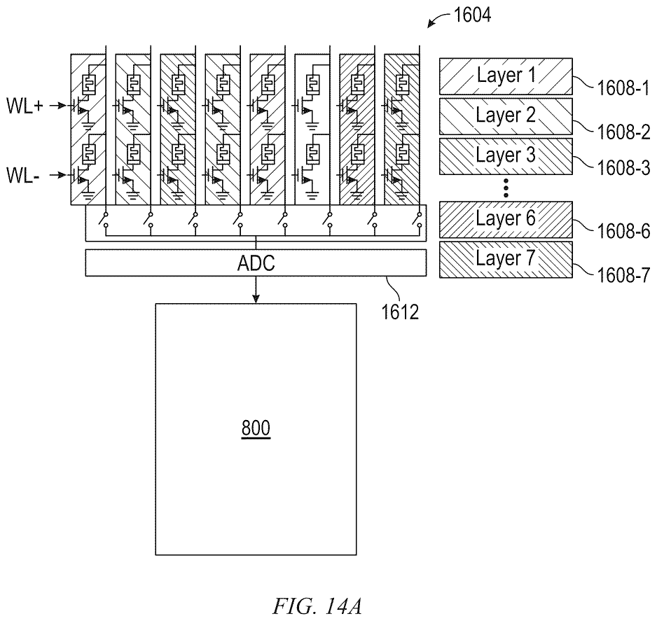

FIG. 13 illustrates the application of the above principles to 3D AIMC accelerators to perform partial sum accumulation, in accordance with example embodiments. The post processing unit presented in FIG. 8 can also be adopted in 3D AIMC accelerators. There are some cases where the size (in particular, the number of rows of the weight matrix) of the layer to map in the AIMC tier is larger than the number of rows available in the AIMC tier. In this case, the layer weights can be split into two or more different AIMC tiers and the resulting output can be accumulated in a shared digital block. The exemplary bit selection methods can be implemented as an extension to the AIMC tile post-processing logic, as shown in FIG. 8 and can be used to perform the partial sum accumulation of the outputs of the different tiers involved in the computations. In this case, one PPU with the accumulation flow support can be multiplexed across different tiers and can receive the inputs sequentially from different tiers to accumulate after performing affine correction to each output. In this way, the partial sum accumulation is performed in a larger bit-width using the SIGN_EXT parameter, depending on the desired maximum number of accumulations (K) to be performed. Then, once all the desired number of accumulations are performed and the last accumulation is achieved, the disclosed circuit will cut Q MSBs and L LSBs depending on the number of accumulations (K) performed, where Q and L are computed with the disclosed bit selection methods.

### Embodiment 10—Partial Sum Accumulation with Weight Sets in AIMC (In-tile Accumulation)

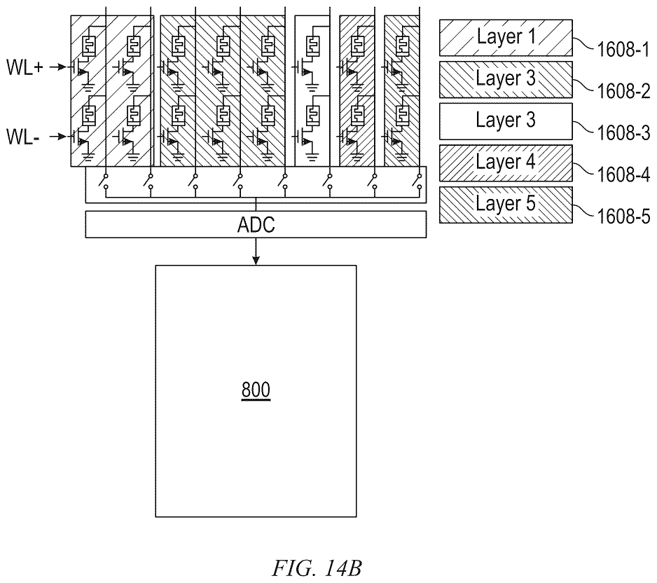

FIG. 14A illustrates the application of the above principles to AIMC accelerators to perform accumulation of different weight-set results where each tile can store multiple weight sets, in accordance with example embodiments. In this case, the weights of different layers can be mapped into different AIMC tile weight sets and, if the outputs of two or more layers need to be accumulated, they can be accumulated in a shared digital block. The exemplary bit selection methods can be implemented as an extension to the AIMC tile post-processing logic, as shown in FIG. 8 and can be used to perform the partial sum accumulation of the outputs of the different weight-sets from distinct layers involved in the computations. In this case, one PPU with the accumulation flow support will receive the inputs sequentially from different weight-sets from distinct layers 1608-1, 1608-2, 1608-3, . . . , 1608-6, 1608-7 to accumulate, after performing affine correction to each output. In this way, the partial sum accumulation is performed in a larger bit-width using the SIGN_EXT parameter, depending on the desired maximum number of accumulations (K) to be performed. Then, once all the desired number of accumulations is performed and the last accumulation is achieved, the exemplary circuit cuts Q MSBs and L LSBs depending on the number of accumulations (K) performed, where Q and L are computed with the exemplary bit selection methods.

FIG. 14B illustrates the application of the above principles to AIMC accelerators to perform partial sum accumulation on weight-sets where each tile can store multiple weight sets, in accordance with example embodiments. The post processing unit presented in FIG. 8 can be adopted in AIMC accelerators where each tile can store multiple weight sets. However, a weight can be mapped to multiple weight-sets to increase the precision of a weight representation. The exemplary bit selection methods can be implemented as an extension to the AIMC tile post-processing logic, as shown in FIG. 8 and can be used to perform the partial sum accumulation of the outputs of the different weight-sets involved in the computations. In this case, one PPU with the accumulation flow support will receive the inputs sequentially from different weight-sets belonging to the same layer to accumulate, after performing affine correction to each output. For instance, the bit lines 1 and 2 from the left belong to Layer 1. To complete partial sum accumulation for Layer 1, they should be accumulated sequentially within the PPU. In this way, the partial sum accumulation is performed in a larger bit-width using the SIGN_EXT parameter, depending on the desired maximum number of accumulations (K) to be performed. Then, once all the desired number of accumulations are performed and the last accumulation is achieved, the disclosed circuit will cut Q MSBs and L LSBs depending on the number of accumulations (K) performed, where Q and L are computed with the exemplary bit selection methods.

### Performance Evaluation (N=9b)

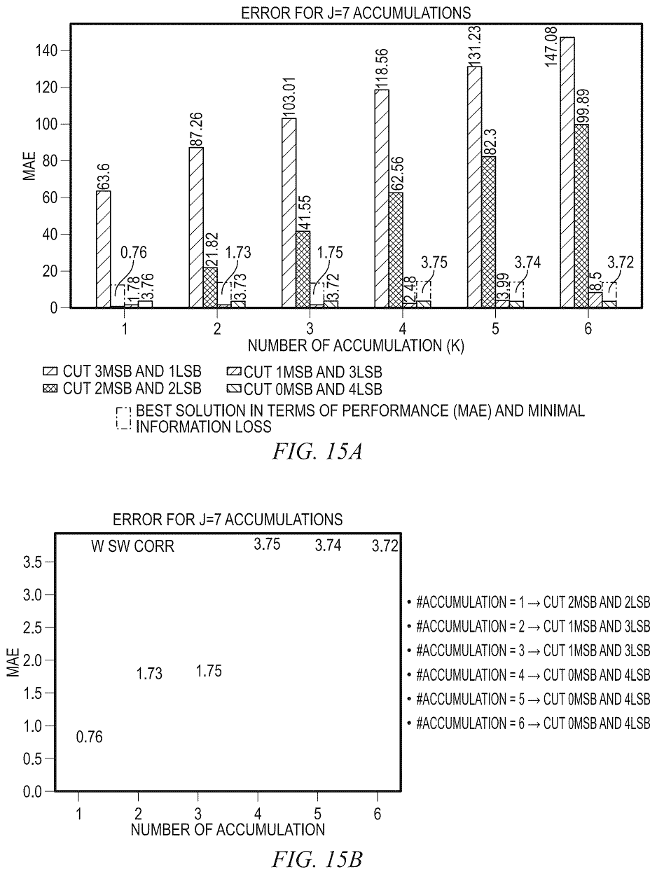

FIG. 15A is a histogram of performance (measured with a mean absolute error (MAE) metric) of different cutting schemes for different numbers of accumulations, in accordance with example embodiments. FIG. 15A shows the precision loss that is incurred by the exemplary accumulation scheme. For this purpose, the input bit size was set to nine bits and the maximum number of accumulations was set to six. The errors are averaged over 10,000 data instances. The exemplary algorithm chooses the best solution as highlighted with the rectangular box. The best accumulation scheme is defined in terms of the minimum absolute error and minimal information loss, which means the exemplary algorithm takes into account the sign bit. Thus, the exemplary algorithm actually selects the best result to retain the sign bit, which is an important bit to minimize the outliers in the results. The state-of-the-art bit selection is cutting only the LSBs which is shown with the right-most bars. In most of the cases, example embodiments perform better than the state-of-the-art solution in terms of the mean absolute error.

FIG. 15B is a histogram of performance (mean absolute error (MAE) metric) for different numbers of accumulations, in accordance with example embodiments. In the example of FIG. 15B, J=7 (where the maximum number of accumulations is 7−1=6) when adopting different methodologies to reduce the bit of the accumulation results to the desired number of output bits. In the case where the ‘number of accumulations’=4 (K=4), the exemplary methodology does not select to cut 1 MSB and 3 LSBs, despite its better than average performance compared to cutting 0 MSBs and 4 LSBs. This is to avoid specific corner cases where cutting 1 MSB results in the loss of sign information.

### Performance Evaluation (N=9b, J=10)

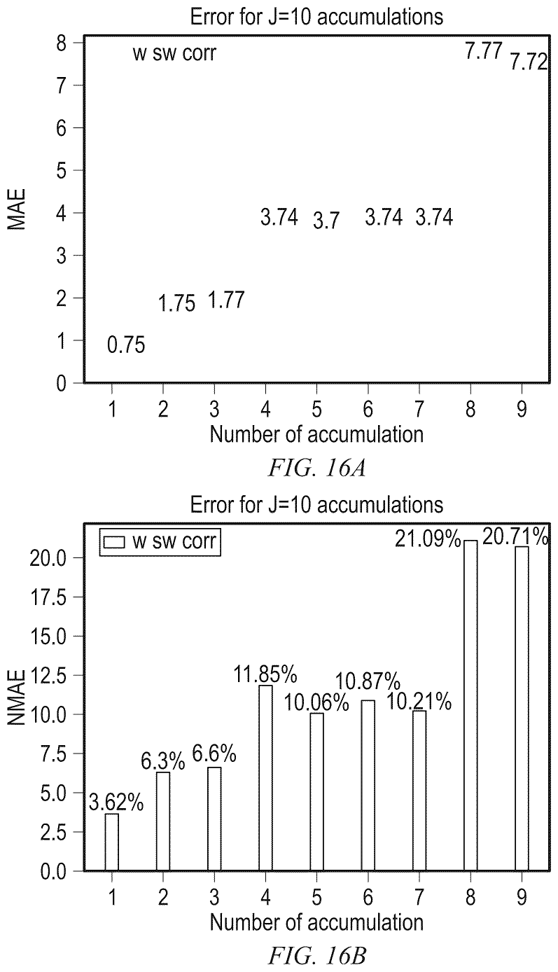

FIG. 16A is a histogram of performance (mean absolute error (MAE) metric) for different numbers of accumulations, in accordance with example embodiments. FIG. 16B is a histogram of performance (normalized mean absolute error (NMAE) metric) for different numbers of accumulations, in accordance with example embodiments. In the examples of FIGS. 16A and 16B, J=10 (where the maximum number of accumulations is 10−1=9) when adopting different methodologies to reduce the bit of the accumulation results to the desired number of output bits. In the examples of FIGS. 16A and 16B, the input bit width is kept constant (N=9 bits (an integer of 8 bits and a fractional portion of 1 bit) and an output of 8 bits). It can be seen that, as the number of accumulations increases, both the mean absolute error and the normalized mean absolute error of the exemplary algorithm increases. In this context, the “normalized mean absolute error” means that the errors are normalized to the magnitude of the input. Use of the normalized mean absolute error thus gives a better understanding of the quantization error as it does not depend on the magnitude of the input (basically normalizing each error to their magnitudes)). For example, a quantization error of 1 has varying significance depending on the actual data value. For instance, when the data is 4, this error represents a larger relative impact compared to when the data is 128. Thus, the mean absolute error stays minimal for most accumulation cases but, as the last ones are approached, it performs worse than the initial steps, since more LSBs are being cut (which might also contain significant information).

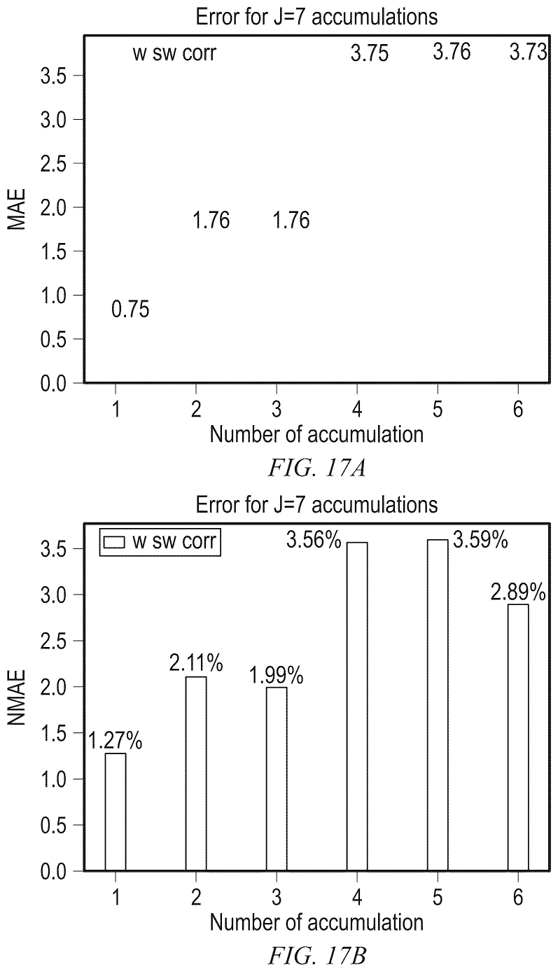

FIG. 17A is a histogram of performance (mean absolute error (MAE) metric) for different numbers of accumulations, in accordance with example embodiments. FIG. 17B is a histogram of performance (normalized mean absolute error (NMAE) metric) for different numbers of accumulations, in accordance with example embodiments. In the examples of FIGS. 17A and 17B, J=7 (where the maximum number of accumulations=7−1=6) when adopting different methodologies to reduce the bit of the accumulation results to the desired number of output bits. In the examples of FIGS. 17A and 17B, the input bit width constant is kept constant (N=11 bits (an integer of 10 bits and a fractional portion of 1 bit) and an output of 10 bits).

Given the discussion thus far, it will be appreciated that, in general terms, an exemplary method, according to an aspect of the invention, includes the operations of computing a count of bits of a design of an accumulation register 724 (a minimal size of the accumulation register 724) that ensures that a final accumulated value conforms to a specified precision and determining a sign extension (SIGN_EXT) parameter that defines a count of extension bits of the accumulation register 724 (operation 604); computing a count of most significant bits (MSBs) and a count of least significant bits (LSBs) to cut for each of a set of candidate steps (0, 1, . . . , K−1) of an accumulation loop; performing an accumulation of a given count of numbers for the accumulation register 724 design; selecting a set of bits of the accumulation register 724 design to output after completion of the performance of the accumulation operation based on the count of most significant bits (MSBs) and the count of least significant bits (LSBs); and instantiating an electronic circuit 800, the electronic circuit 800 comprising a physical accumulation register 724 that is configured to output the selected set of bits of the accumulation register 724 design.

In some cases, the electronic circuit further comprises a truncation block 728, and the method further comprises configuring the truncation block 728 to output the selected set of bits of the accumulation register 724 and performing calculations using the electronic circuit 800.

In some instances, computing the count of most significant bits (MSBs) and a count of least significant bits (LSBs) is dependent on a maximum accumulation step (K), the input and output bit size of accumulation, and the determining of the sign extension parameter is based on a final sign extension parameter and further comprises: initializing a variable var1 to two, initializing a variable var2 to one and initializing a counter to zero (operation 608); performing a check to determine whether the counter is greater than a count of accumulations K to perform (operation 612); performing a check to determine whether the count of accumulations K to perform is greater than (var1+ (var1−1)) in response to the counter not being greater than the count of accumulations (K) to perform (NO branch of operation 612) (operation 616); increasing the variable var1 based on var1=var1*2 and increasing the variable var2 based on var2=var2+1 in response to the count of accumulations K being greater than (var1+ (var1−1)) (YES branch of operation 616) (operation 620); and determining the count of most significant bits (MSBs) to cut and the count of least significant bits (LSBs) to cut based on MSB_CUT.append(SIGN_EXT_FINAL−int(floor(i/var1))−var2) and LSB_CUT.append((SIGN_EXT_FINAL+N+FRAC)−MSB_CUT[i]−N) and incrementing the counter, where N is a size of input data (operation 624). Refer to the definition of SIGN_EXT_FINAL above.

In some embodiments, computing the count of most significant bits (MSBs) and a count of least significant bits (LSBs) is dependent on a maximum accumulation step (K), the input and output bit size of accumulation and further comprises: initializing a variable var1 to two, initializing a variable var2 to one and initializing a counter to zero (operation 608); performing a check to determine whether the counter is greater than a count of accumulations K to perform (operation 612); performing a check to determine whether the count of accumulations K to perform is greater than (var1+ (var1−1)) in response to the counter not being greater than the count of accumulations (K) to perform (NO branch of operation 612) (operation 616); increasing the variable var1 based on var1=var1*2 and increasing the variable var2 based on var2=var2+1 in response to the count of accumulations K being greater than (var1+ (var1−1)) (YES branch of operation 616) (operation 620); and determining the count of most significant bits (MSBs) to cut and the count of least significant bits (LSBs) to cut based on MSB_CUT.append(SIGN_EXT−int(floor(i/var1))−var2) and LSB_CUT.append((SIGN_EXT+N+FRAC)−MSB_CUT[i]−N) and incrementing the counter, where N is a size of input data (operation 624).

Some such embodiments further include ending the method in response to the counter being greater than the number of accumulations (K) to perform during a subsequent iteration of the method (YES branch of operation 612).

In some such embodiments, the determining of the count of most significant bits (MSBs) to cut and the count of least significant bits (LSBs) to cut is performed (operation 624) in response to one or more of: performing the increasing of the variables var1 and var2 (operation 620); the count of accumulations K not being greater than (var1+ (var1−1)) (NO branch of operation 616) during a subsequent iteration of the method.

In some cases, the bits selected to output from the accumulation register 724 are pre-selected at a configuration time.

Some instances further include obtaining a maximum number of accumulations (K) to perform, a size of an input value (N_int+N_frac) for the accumulation register 724 and a size of an output value (N_out≥N_int) of the accumulation register 724.

Some embodiments further include outputting the sign extension parameter (SIGN_EXT) and a list defining the most significant bits (MSBs) to cut at each step and a list defining least significant bits (LSBs) to cut at each step.

In another aspect, an electronic circuit includes: an accumulation register 724 configured with a specified number of extension bits based on an estimated sign extension parameter (block 704), the sign extension parameter being based on a given count of accumulation operations; a truncation block 728 configured to cut a specified set of bits of an output of the accumulation register 724; a counter 712 configured to track of a count of accumulations that have been performed; a demultiplexer 720 configured to select an output of the demultiplexer 720 coupled to an input of the accumulation register 724 when an output of the counter 712 is less than the given count of accumulation operations and to select an output of the demultiplexer 720 coupled to an input of the truncation block 728 when an output of the counter 712 is not less than the given count of accumulation operations; an adder 708 configured to add an input of the electronic circuit to a current value in the accumulation register 724 during each accumulation operation, wherein the electronic circuit is configured to store a result of the adder 708 in the accumulation register 724 via the demultiplexer 720; and a comparator 716 configured to change a selection of the demultiplexer 720 when the count of accumulation operations equals the given count of accumulation operations to provide a final result from the accumulation register 724 to the truncation block 728.

In some cases, the truncation block 728 cuts an appropriate count of most significant bits (MSBs) and an appropriate count of least significant bits (LSBs) as defined by a given list for the most significant bits (MSBs) and a given list for the least significant bits (LSBs), respectively, where the appropriate count of most significant bits (MSBs) is defined by Q=MSB_CUT[K−1] and where the appropriate count of least significant bits (LSBs) is defined by L=LSB_CUT[K−1].

In some instances, the MSB_CUT[0:J−2] and LSB_CUT[0:J−2] are stored as internal parameters, wherein J is a maximum count of numbers to accumulate.

In still another aspect, a hardware description language (HDL) design structure is encoded on a machine-readable data storage medium, and the HDL design structure comprising elements that when processed in a computer-aided design system generates a machine-executable representation of a semiconductor structure, wherein the HDL design structure comprises one, some, or all of the electronic circuit elements described herein.

In yet another aspect, a computer program product includes one or more tangible computer-readable storage media and program instructions stored on at least one of the one or more tangible computer-readable storage media, the program instructions executable by a processor, the program instructions comprising any one, some, or all of the method steps disclosed herein (or facilitating such steps).

Refer now to FIG. 18.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as software in accordance with aspects of the invention that can assist in the design of an AIMC system 200 and/or software that can facilitate a process such as is shown in FIG. 19. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Exemplary Design Process Used in Semiconductor Design, Manufacture, and/or Test

One or more embodiments make use of computer-aided semiconductor integrated circuit design simulation, test, layout, and/or manufacture. In this regard, FIG. 19 shows a block diagram of an exemplary design flow 1900 used for example, in semiconductor IC logic design, simulation, test, layout, and manufacture. Design flow 1900 includes processes, machines and/or mechanisms for processing design structures or devices to generate logically or otherwise functionally equivalent representations of design structures and/or devices, such as those that can be analyzed using techniques disclosed herein or the like. The design structures processed and/or generated by design flow 1900 may be encoded on machine-readable storage media to include data and/or instructions that when executed or otherwise processed on a data processing system generate a logically, structurally, mechanically, or otherwise functionally equivalent representation of hardware components, circuits, devices, or systems. Machines include, but are not limited to, any machine used in an IC design process, such as designing, manufacturing, or simulating a circuit, component, device, or system. For example, machines may include: lithography machines, machines and/or equipment for generating masks (e.g. e-beam writers), computers or equipment for simulating design structures, any apparatus used in the manufacturing or test process, or any machines for programming functionally equivalent representations of the design structures into any medium (e.g. a machine for programming a programmable gate array).

Design flow 1900 may vary depending on the type of representation being designed. For example, a design flow 1900 for building an application specific IC (ASIC) may differ from a design flow 1900 for designing a standard component or from a design flow 1900 for instantiating the design into a programmable array, for example a programmable gate array (PGA) or a field programmable gate array (FPGA) offered by Altera® Inc, or Xilinx® Inc.

FIG. 19 illustrates multiple such design structures including an input design structure 1920 that is preferably processed by a design process 1910. Design structure 1920 may be a logical simulation design structure generated and processed by design process 1910 to produce a logically equivalent functional representation of a hardware device. Design structure 1920 may also or alternatively comprise data and/or program instructions that when processed by design process 1910, generate a functional representation of the physical structure of a hardware device. Whether representing functional and/or structural design features, design structure 1920 may be generated using electronic computer-aided design (ECAD) such as implemented by a core developer/designer. When encoded on a gate array or storage medium or the like, design structure 1920 may be accessed and processed by one or more hardware and/or software modules within design process 1910 to simulate or otherwise functionally represent an electronic component, circuit, electronic or logic module, apparatus, device, or system. As such, design structure 1910 may comprise files or other data structures including human and/or machine-readable source code, compiled structures, and computer executable code structures that when processed by a design or simulation data processing system, functionally simulate or otherwise represent circuits or other levels of hardware logic design. Such data structures may include hardware-description language (HDL) design entities or other data structures conforming to and/or compatible with lower-level HDL design languages such as Verilog and VHDL, and/or higher level design languages such as C or C++.

Design process 1910 preferably employs and incorporates hardware and/or software modules for synthesizing, translating, or otherwise processing a design/simulation functional equivalent of components, circuits, devices, or logic structures to generate a Netlist 1980 which may contain design structures such as design structure 1920. Netlist 1980 may comprise, for example, compiled or otherwise processed data structures representing a list of wires, discrete components, logic gates, control circuits, I/O devices, models, etc. that describes the connections to other elements and circuits in an integrated circuit design. Netlist 1980 may be synthesized using an iterative process in which netlist 1980 is resynthesized one or more times depending on design specifications and parameters for the device. As with other design structure types described herein, netlist 1980 may be recorded on a machine-readable data storage medium or programmed into a programmable gate array. The medium may be a nonvolatile storage medium such as a magnetic or optical disk drive, a programmable gate array, a compact flash, or other flash memory. Additionally, or in the alternative, the medium may be a system or cache memory, buffer space, or other suitable memory.

Design process 1910 may include hardware and software modules for processing a variety of input data structure types including Netlist 1980. Such data structure types may reside, for example, within library elements 1930 and include a set of commonly used elements, circuits, and devices, including models, layouts, and symbolic representations, for a given manufacturing technology (e.g., different technology nodes, 32 nm, 45 nm, 90 nm, etc.). The data structure types may further include design specifications 1940, characterization data 1950, verification data 1960, design rules 1970, and test data files 1985 which may include input test patterns, output test results, and other testing information. Design process 1910 may further include, for example, standard mechanical design processes such as stress analysis, thermal analysis, mechanical event simulation, process simulation for operations such as casting, molding, and die press forming, etc. One of ordinary skill in the art of mechanical design can appreciate the extent of possible mechanical design tools and applications used in design process 1910 without deviating from the scope and spirit of the invention. Design process 1910 may also include modules for performing standard circuit design processes such as timing analysis, verification, design rule checking, place and route operations, etc.

Design process 1910 employs and incorporates logic and physical design tools such as HDL compilers and simulation model build tools to process design structure 1920 together with some or all of the depicted supporting data structures along with any additional mechanical design or data (if applicable), to generate a second design structure 1990. Design structure 1990 resides on a storage medium or programmable gate array in a data format used for the exchange of data of mechanical devices and structures (e.g. information stored in an IGES, DXF, Parasolid XT, JT, DRG, or any other suitable format for storing or rendering such mechanical design structures). Similar to design structure 1920, design structure 1990 preferably comprises one or more files, data structures, or other computer-encoded data or instructions that reside on data storage media and that when processed by an ECAD system generate a logically or otherwise functionally equivalent form of one or more IC designs or the like. In one embodiment, design structure 1990 may comprise a compiled, executable HDL simulation model that functionally simulates the devices to be analyzed.

Design structure 1990 may also employ a data format used for the exchange of layout data of integrated circuits and/or symbolic data format (e.g. information stored in a GDSII (GDS2), GL1, OASIS, map files, or any other suitable format for storing such design data structures). Design structure 1990 may comprise information such as, for example, symbolic data, map files, test data files, design content files, manufacturing data, layout parameters, wires, levels of metal, vias, shapes, data for routing through the manufacturing line, and any other data required by a manufacturer or other designer/developer to produce a device or structure as described herein (e.g., .lib files). Design structure 1990 may then proceed to a stage 1995 where, for example, design structure 1990: proceeds to tape-out, is released to manufacturing, is released to a mask house, is sent to another design house, is sent back to the customer, etc.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
computing a count of bits of a design of an accumulation register that ensures that a final accumulated value conforms to a specified precision and determining a sign extension parameter that defines a count of extension bits of the accumulation register;
computing a count of most significant bits (MSBs) and a count of least significant bits (LSBs) to cut for each of a set of candidate steps of an accumulation loop;
performing an accumulation of a given count of numbers for the accumulation register design;
selecting a set of bits of the accumulation register design to output after completion of the performance of the accumulation operation based on the count of most significant bits (MSBs) and the count of least significant bits (LSBs); and
instantiating an electronic circuit, the electronic circuit comprising a physical accumulation register that is configured to output the selected set of bits of the accumulation register design.

2. The method of claim 1, wherein the electronic circuit further comprises a truncation block, and the method further comprises configuring the truncation block to output the selected set of bits of the accumulation register and performing calculations using the electronic circuit.

3. The method of claim 1, wherein computing the count of most significant bits (MSBs) and a count of least significant bits (LSBs) is dependent on a maximum accumulation step, the input and output bit size of accumulation, wherein the determining of the sign extension parameter is based on a final sign extension parameter and further comprises:
initializing a variable var1 to two, initializing a variable var2 to one and initializing a counter to zero;
performing a check to determine whether the counter is greater than a count of accumulations K to perform;
performing a check to determine whether the count of accumulations K to perform is greater than (var1+ (var1−1)) in response to the counter not being greater than the count of accumulations to perform;
increasing the variable var1 based on var1=var1*2 and increasing the variable var2 based on var2=var2+1 in response to the count of accumulations K being greater than (var1+ (var1−1)); and
determining the count of most significant bits (MSBs) to cut and the count of least significant bits (LSBs) to cut based on MSB_CUT.append(SIGN_EXT_FINAL−int(floor(i/var1))−var2) and LSB_CUT.append((SIGN_EXT_FINAL+N+FRAC)−MSB_CUT[i]−N) and incrementing the counter, where N is a size of input data.

4. The method of claim 1, wherein computing the count of most significant bits (MSBs) and a count of least significant bits (LSBs) is dependent on a maximum accumulation step, the input and output bit size of accumulation and further comprises:
initializing a variable var1 to two, initializing a variable var2 to one and initializing a counter to zero;
performing a check to determine whether the counter is greater than a count of accumulations K to perform;
performing a check to determine whether the count of accumulations K to perform is greater than (var1+ (var1−1)) in response to the counter not being greater than the count of accumulations to perform;
increasing the variable var1 based on var1=var1*2 and increasing the variable var2 based on var2=var2+1 in response to the count of accumulations K being greater than (var1+ (var1−1)); and
determining the count of most significant bits (MSBs) to cut and the count of least significant bits (LSBs) to cut based on MSB_CUT.append(SIGN_EXT−int(floor(i/var1))−var2) and LSB_CUT.append((SIGN_EXT+N+FRAC)−MSB_CUT[i]−N) and incrementing the counter, where N is a size of input data.

5. The method of claim 4, further comprising ending the method in response to the counter being greater than the number of accumulations to perform during a subsequent iteration of the method.

6. The method of claim 4, wherein the determining of the count of most significant bits (MSBs) to cut and the count of least significant bits (LSBs) to cut is performed in response to one or more of:
performing the increasing of the variables var1 and var2; and
the count of accumulations K not being greater than (var1+ (var1−1)) during a subsequent iteration of the method.

7. The method of claim 1, whereby the bits selected to output from the accumulation register are pre-selected at a configuration time.

8. The method of claim 1, further comprising obtaining a maximum number of accumulations to perform, a size of an input value for the accumulation register and a size of an output value of the accumulation register.

9. The method of claim 1, further comprising outputting the sign extension parameter and a list defining the most significant bits (MSBs) to cut at each step and a list defining least significant bits (LSBs) to cut at each step.

10. An electronic circuit comprising:
an accumulation register configured with a specified number of extension bits based on an estimated sign extension parameter, the sign extension parameter being based on a given count of accumulation operations;
a truncation block configured to cut a specified set of bits of an output of the accumulation register;
a counter configured to track of a count of accumulations that have been performed;
a demultiplexer configured to select an output of the demultiplexer coupled to an input of the accumulation register when an output of the counter is less than the given count of accumulation operations and to select an output of the demultiplexer coupled to an input of the truncation block when an output of the counter is not less than the given count of accumulation operations;
an adder configured to add an input of the electronic circuit to a current value in the accumulation register during each accumulation operation, wherein the electronic circuit is configured to store a result of the adder in the accumulation register via the demultiplexer; and
a comparator configured to change a selection of the demultiplexer when the count of accumulation operations equals the given count of accumulation operations to provide a final result from the accumulation register to the truncation block.

11. The electronic circuit of claim 10, wherein the truncation block cuts an appropriate count of most significant bits (MSBs) and an appropriate count of least significant bits (LSBs) as defined by a given list for the most significant bits (MSBs) and a given list for the least significant bits (LSBs), respectively, where the appropriate count of most significant bits (MSBs) is defined by Q=MSB_CUT[K−1] and where the appropriate count of least significant bits (LSBs) is defined by L=LSB_CUT[K−1].

12. The electronic circuit of claim 10, wherein the MSB_CUT[0:J−2] and LSB_CUT[0:J−2] are stored as internal parameters, wherein J is a maximum count of numbers to accumulate.

13. A hardware description language (HDL) design structure encoded on a machine-readable data storage medium, the HDL design structure comprising elements that when processed in a computer-aided design system generates a machine-executable representation of a semiconductor structure, wherein the HDL design structure comprises:
an accumulation register configured with a specified number of extension bits based on an estimated sign extension parameter, the sign extension parameter being based on a given count of accumulation operations;
a truncation block configured to cut a specified set of bits of an output of the accumulation register;
a counter configured to track of a count of accumulations that have been performed;
a demultiplexer configured to select an output of the demultiplexer coupled to an input of the accumulation register when an output of the counter is less than the given count of accumulation operations and to select an output of the demultiplexer coupled to an input of the truncation block when an output of the counter is not less than the given count of accumulation operations;
an adder configured to add an input of the electronic circuit to a current value in the accumulation register during each accumulation operation, wherein the electronic circuit is configured to store a result of the adder in the accumulation register via the demultiplexer; and
a comparator configured to change a selection of the demultiplexer when the count of accumulation operations equals the given count of accumulation operations to provide a final result from the accumulation register to the truncation block.

14. The HDL design structure of claim 13, wherein the truncation block cuts an appropriate count of most significant bits (MSBs) and an appropriate count of least significant bits (LSBs) as defined by a given list for the most significant bits (MSBs) and a given list for the least significant bits (LSBs), respectively, where the appropriate count of most significant bits (MSBs) is defined by Q=MSB_CUT[K−1] and where the appropriate count of least significant bits (LSBs) is defined by L=LSB_CUT[K−1].

15. The HDL design structure of claim 13, wherein the MSB_CUT[0:J−2] and LSB_CUT[0:J−2] are stored as internal parameters, wherein J is a maximum count of numbers to accumulate.

16. A computer program product, comprising:
one or more tangible computer-readable storage media and program instructions stored on at least one of the one or more tangible computer-readable storage media, the program instructions executable by a processor, the program instructions comprising:
computing a count of bits of a design of an accumulation register that ensures that a final accumulated value conforms to a specified precision and determining a sign extension parameter that defines a count of extension bits of the accumulation register;
computing a count of most significant bits (MSBs) and a count of least significant bits (LSBs) to cut for each of a set of candidate steps (0,1, . . . , K−1) of an accumulation loop;
performing an accumulation of a given count of numbers for in the accumulation register design;
selecting a set of bits of the accumulation register design to output after completion of the performance of the accumulation operation based on the count of most significant bits (MSBs) and the count of least significant bits (LSBs); and
facilitating instantiating an electronic circuit, the electronic circuit comprising a physical accumulation register that is configured to output the selected set of bits of the accumulation register design.

17. The computer program product of claim 16, wherein the electronic circuit further comprises a truncation block, and the method further comprises configuring the truncation block to output the selected set of bits of the accumulation register and performing calculations using the electronic circuit.

18. The computer program product of claim 16, wherein the computing the count of most significant bits (MSBs) and a count of least significant bits (LSBs) is dependent on a maximum accumulation step, the input and output bit size of accumulation, wherein the determining of the sign extension parameter is based on a final sign extension parameter and further comprises:
initializing a variable var1 to two, initializing a variable var2 to one and initializing a counter to zero;
performing a check to determine whether the counter is greater than a count of accumulations K to perform;
performing a check to determine whether the count of accumulations K to perform is greater than (var1+ (var1−1)) in response to the counter not being greater than the count of accumulations to perform;
increasing the variable var1 based on var1=var1*2 and increasing the variable var2 based on var2=var2+1 in response to the count of accumulations K being greater than (var1+ (var1−1)); and
determining the count of most significant bits (MSBs) to cut and the count of least significant bits (LSBs) to cut based on MSB_CUT.append(SIGN_EXT_FINAL−int(floor(i/var1))−var2) and LSB_CUT.append((SIGN_EXT_FINAL+N+FRAC)−MSB_CUT[i]−N) and incrementing the counter, where N is a size of input data.

19. The computer program product of claim 16, wherein the computing the count of most significant bits (MSBs) and a count of least significant bits (LSBs) is dependent on a maximum accumulation step, the input and output bit size of accumulation and further comprises:
initializing a variable var1 to two, initializing a variable var2 to one and initializing a counter to zero;
performing a check to determine whether the counter is greater than a count of accumulations K to perform;
performing a check to determine whether the count of accumulations K to perform is greater than (var1+ (var1−1)) in response to the counter not being greater than the count of accumulations to perform;
increasing the variable var1 based on var1=var1*2 and increasing the variable var2 based on var2=var2+1 in response to the count of accumulations K being greater than (var1+ (var1−1)); and
determining the count of most significant bits (MSBs) to cut and the count of least significant bits (LSBs) to cut based on MSB_CUT.append(SIGN_EXT−int(floor(i/var1))−var2) and LSB_CUT.append((SIGN_EXT+N+FRAC)−MSB_CUT[i]−N) and incrementing the counter, where N is a size of input data.

20. The computer program product of claim 16, further comprising ending the method in response to the counter being greater than the number of accumulations to perform during a subsequent iteration of the method.
